(19) United States
(12) Patent Application Publication
(10) Pub. No.: US 2025/0240349 A1
(43) Pub. Date: Jul. 24, 2025

(54) SYSTEMS AND METHODS FOR OPERATING A NETWORK OF UNIT COLLECTION DEVICES

(71) Applicant: NEUROFY CORPORATION, Whiting, IN (US)

(72) Inventors: Arash Sheikhtaheri, Aurora (CA); Aria Sheikhtaheri, North (CA); Martin Zeltner, Uxbridge (CA)

(21) Appl. No.: 19/035,173

(22) Filed: Jan. 23, 2025

Related U.S. Application Data
(60) Provisional application No. 63/624,076, filed on Jan. 23, 2024.

(51) Int. Cl. H04L 67/12

(52) U.S. Cl. CPC H04L 67/12

(57) ABSTRACT

System and methods for operating a network of unit collection devices (UCDs). The system may include a plurality of UCDs. Each UCD may be associated with a respective portable structure. The UCDs may receive sensor data indicating a status of the portable structures, operate as a node in a mesh network, and provide the sensor data to a coordinator UCD of the mesh network. The coordinator UCD may generate an aggregate sensor dataset from the received sensor data. The system may include a network collection device (NCD) for collecting the aggregate sensor dataset from the coordinator UCD, and providing the aggregate sensor dataset to a storage platform. The NCD may receive, from the coordinator UCD, the aggregate sensor dataset in response to the NCD being within wireless communication range of the coordinator UCD. The NCD may provide the aggregate sensor dataset to a data storage platform.

### CROSS-REFERENCE TO RELATED APPLICATIONS

The present disclosure claims priority to U.S. Provisional Application 63/624,076 filed Jan. 23, 2024, the entire contents of which are hereby incorporated by reference.

### FIELD OF THE DISCLOSURE

The present disclosure generally relates to unit collection devices (UCDs), and more particularly, to systems and methods for operating a network of UCDs.

### BACKGROUND

Providing sensor data by UCDs associated with a network of portable structures (such as toilets) may provide a portable structure supplier and/or consumer valuable information associated with the status of each portable structure, which can be used to service the structures and generate useful data analytics, among other things, while also avoiding the need for a manual inspection of the toilets to determine their status. However, the portable structures comprising the network may be located in multiple, and far-reaching, locations, such that collecting the data from each and every UCD associated with a portable structure may be just as arduous a task as traveling to the structure locations to inspect them.

Therefore, there is an opportunity to provide improvements in, and a need for systems and methods for, operating a network of UCDs.

### BRIEF SUMMARY

The present embodiments may relate to, inter alia, systems and methods for operating a network of unit collection devices (UCDs).

In one aspect, a system for operating a network of UCDs. The system may include a plurality of UCDs, wherein each UCD of the plurality of UCDs may be associated with a respective portable structure. Each UCD may be configured to (i) receive sensor data from one or more sensors, the sensor data indicating a status of the respective portable structure; (ii) operate as a node in a long-range wireless mesh network comprising the plurality of UCDs; (iii) provide the sensor data to a coordinator UCD of the long-range wireless mesh network; and (iv) operate as the coordinator UCD for at least a portion of UCDs of the plurality of UCDs. The coordinator UCD may (i) generate an aggregate sensor dataset from the sensor data received from the at least the portion of UCDs, wherein the received sensor data may include UCD identifiers associated with the UCDs from which the sensor data is received, and (ii) store the aggregate sensor dataset locally on a memory. The system may include a network collection device (NCD) for collecting the aggregate sensor dataset from the coordinator UCD, and providing the aggregate sensor dataset to a storage platform. The NCD may be configured to: (i) receive, from the coordinator UCD, the aggregate sensor dataset in response to the NCD being within wireless communication range of the coordinator UCD; and (ii) provide the aggregate sensor dataset to a data storage platform. The system may include additional, less, or alternate functionality, including that discussed elsewhere herein.

In another aspect, a method for operating a network of UCDs implemented by (i) a plurality of UCDs, wherein each UCD of the plurality of UCDs may be associated with a respective portable structure, and may be configured to operate as a node in a long-range wireless mesh network comprising the plurality of UCDs, and may operate as a coordinator UCD for at least a portion of UCDs of the plurality of UCDs; and (ii) an NCD may be configured to collect an aggregate sensor dataset from the coordinator UCD, and may provide the aggregate sensor dataset to a storage platform. The method may include (i) receiving, from one or more sensors by the each UCD, sensor data indicating a status of the respective portable structure; (ii) providing, by the at least the portion of UCDs to the coordinator UCD, the sensor data; (iii) generating, by the coordinator UCD, an aggregate sensor dataset from the sensor data received from the at least the portion of UCDs, wherein the received sensor data may include UCD identifiers associated with the UCDs from which the sensor data is received; (iv) storing, by the coordinator UCD, the aggregate sensor dataset locally on a memory; (v) receiving, by the NCD from the coordinator UCD, the aggregate sensor dataset based upon the NCD being within wireless communication range of the coordinator UCD; and (vi) providing, by the NCD to a data storage platform, the aggregate sensor dataset. The method may include additional, less, or alternate functionality or actions, including those discussed elsewhere herein.

In yet another aspect, a non-transitory computer-readable storage medium storing processor-executable instructions for operating a network of UCDs and implemented by (i) a plurality of UCDs, wherein each UCD of the plurality of UCDs may be associated with a respective portable structure, and may be configured to operate as a node in a long-range wireless mesh network comprising the plurality of UCDs, and may operate as a coordinator UCD for at least a portion of UCDs of the plurality of UCDs; and (ii) a NCD may be configured to collect an aggregate sensor dataset from the coordinator UCD, and may provide the aggregate sensor dataset to a storage platform. The instructions, when executed by one or more processors, may cause the one or more processors to at least: (i) receive, from one or more sensors by the each UCD, sensor data indicating a status of the respective portable structure; (ii) provide, by the at least the portion of UCDs to the coordinator UCD, the sensor data; (iii) generate, by the coordinator UCD, an aggregate sensor dataset from the sensor data received from the at least the portion of UCDs, wherein the received sensor data may include UCD identifiers associated with the UCDs from which the sensor data is received; (iv) store, by the coordinator UCD, the aggregate sensor dataset locally on a memory; (v) receive, by the NCD from the coordinator UCD, the aggregate sensor dataset in response to the NCD being within wireless communication range of the coordinator UCD; and (vi) provide, by the NCD to a data storage platform, the aggregate sensor dataset. The instructions may direct additional, less, or alternate functionality, including that discussed elsewhere herein.

In still yet another aspect, a system for operating a network of UCDs. The system may include a plurality of UCDs, wherein each UCD of the plurality of UCDs is associated with a respective portable structure. Each UCD may be configured to: (i) receive sensor data from one or more sensors, the sensor data indicating a status of the respective portable structure; (ii) operate as a node in a long-range wireless mesh network comprising the plurality of UCDs; (iii) provide the sensor data to a coordinator UCD of the long-range wireless mesh network> The system may include the coordinator UCD for at least a portion of UCDs of the plurality of UCDs. The coordinator UCD may be configured to: (i) receive the aggregate sensor dataset from the plurality of UCDs via the long-range wireless mesh network wherein the received sensor data includes UCD identifiers associated with the UCDs from which the sensor data is received, (ii) generate an aggregate sensor dataset from the sensor data received from the at least the portion of UCDs, (iii) store the aggregate sensor dataset locally on a memory, and (iv) provide the aggregate sensor dataset to a storage platform via one or more long-range communication connections. The system may include additional, less, or alternate functionality, including that discussed elsewhere herein.

In another aspect, a method for operating a network of UCDs. The method may be implemented by a plurality of UCDs, wherein each UCD of the plurality of UCDs is associated with a respective portable structure and configured to operate as a node in a long-range wireless mesh network comprising the plurality of UCDs, and a coordinator UCD for at least a portion of UCDs of the plurality of UCDs, the coordinator UCD configured to receive the sensor data, generate an aggregate sensor dataset from the sensor data, and provide the aggregate sensor dataset to a storage platform. The method may include (i) receiving, from one or more sensors by the each UCD, sensor data indicating a status of the respective portable structure; (ii) providing, by the at least the portion of UCDs to the coordinator UCD via the long-range wireless mesh network, the sensor data; (iii) generating, by the coordinator UCD, an aggregate sensor dataset from the sensor data received from the at least the portion of UCDs, wherein the received sensor data includes UCD identifiers associated with the UCDs from which the sensor data is received; (iv) storing, by the coordinator UCD, the aggregate sensor dataset locally on a memory; and (v) providing, by the coordinator UCD to a data storage platform via one or more long-range communication connections, the aggregate sensor dataset. The method may include additional, less, or alternate functionality or actions, including those discussed elsewhere herein.

Additional, alternate and/or fewer actions, steps, features and/or functionality may be included in an aspect and/or embodiments, including those described elsewhere herein.

### BRIEF DESCRIPTION OF THE DRAWINGS

The figures described below depict various aspects of the system and methods disclosed therein. It should be understood that each figure depicts one embodiment of a particular aspect of the disclosed system and methods, and that each of the figures is intended to accord with a possible embodiment thereof. Further, wherever possible, the following description refers to the reference numerals included in the following figures, in which features depicted in multiple figures are designated with consistent reference numerals.

There are shown in the drawings arrangements which are presently discussed, it being understood, however, that the present aspects are not limited to the precise arrangements and instrumentalities shown, wherein:

FIG. 1 depicts a block diagram of an exemplary computing environment in which methods and systems for operating a network of UCDs are implemented, according to one embodiment;

FIG. 2 depicts a block diagram of an exemplary NCD in which computer-implemented methods and systems for operating a network of UCDs are implemented, according to one embodiment;

FIG. 3 depicts a combined block and logic diagram for training a machine learning model, according to one embodiment;

FIG. 4A depicts a block diagram of an exemplary system for operating a network of UCDs, according to one embodiment;

FIG. 4B depicts a block diagram of a first exemplary portable toilet site, according to one embodiment;

FIG. 4C depicts a block diagram of a second exemplary portable toilet site, according to one embodiment;

FIG. 4E depicts a block diagram of a third exemplary portable toilet site, according to one embodiment;

FIG. 4E depicts an exemplary management platform analytics dashboard, according to one embodiment;

FIG. 4F depicts an exemplary user interface of a smartphone NCD, according to one embodiment;

FIG. 5 depicts a flow diagram of an exemplary method for operating a network of UCDs, according to one embodiment.

FIG. 6 depicts a flow diagram of an exemplary method for operating a network of UCDs, according to one embodiment.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### DETAILED DESCRIPTION

### Overview

The computer systems and methods disclosed herein generally relate to, inter alia, operating a network of UCDs. Using the disclosed techniques, an entity may operate a network of UCDs to receive aggregated status information for a plurality of portable structures, providing a supplier and/or consumer valuable information which may be used to service the structures and/or generate useful data analytics. While many of the examples described herein refer to portable toilets, the techniques described herein may be implemented at other structures, such as oil rigs, agricultural structures, portable water fountains, temporary structures built in support of firefighting and/or other disaster relief efforts, and so on.

The disclosed systems and methods may relate to operating a network of UCDs. The system may include a plurality of UCDs. Each UCD of the plurality of UCDs may be associated with a respective portable structure. Each UCD may be configured to receive sensor data from one or more sensors. The sensor data may indicate a status of the respective portable structure, such as a location, a frequency of use, a hygiene level, a door lock status, and/or a level of a consumable product of the portable structure. Each UCD may operate as a node in a long-range wireless mesh network comprising the plurality of UCDs. The long-range wireless mesh network may be a bidirectional mesh network based upon a long-range wireless area network (LoRaWAN) protocol. Each UCD may provide the sensor data to a coordinator UCD of the long-range wireless mesh network.

In at least one embodiment, the coordinator UCD for at least a portion of UCDs of the plurality of UCDs, may be configured to receive the aggregate sensor dataset from the plurality of UCDs via the long-range wireless mesh network, wherein the received sensor data includes UCD identifiers associated with the UCDs from which the sensor data is received. The coordinator UCD may store the aggregate sensor dataset locally on a memory, and/or provide the aggregate sensor dataset to a storage platform via one or more long-range communication connections. The one or more long-rage communication connections may include long term evolution machine type communication, narrowband-internet of things, satellite (e.g., low-earth orbit, high-earth orbit), and/or any other suitable long-rage communication connection. In at least one aspect, at least one of the one or more communication connections may be activated based upon the aggregate sensor dataset, such as based upon the aggregate sensor dataset indicating movement of the portable structure associated with the aggregate sensor dataset. In at least one aspect, one of the one or more communication connections may be subscription-based. In at least one aspect, the coordinator UCD is at least one of the plurality of UCDs. For example, each UCD may be configured to operate as a coordinator UCD. In at least one aspect, the coordinator UCD is a base station.

In at least one embodiment, the system may include a network collection device (NCD) for collecting the aggregate sensor dataset from the coordinator UCD. The NCD may provide the aggregate sensor dataset to the storage platform. The NCD may be configured to receive, from the coordinator UCD, the aggregate sensor dataset in response to the NCD being within wireless communication range of the coordinator UCD. The NCD may be configured to receive the aggregated sensor dataset via a Bluetooth communication connection with the coordinator UCD. The NCD may provide the aggregate sensor dataset to a data storage platform.

The NCD may be configured to obtain, for the long-range wireless mesh network, an expected set of UCD identifiers associated with sensor data expected to be included in the aggregate sensor dataset. The NCD may compare the expected set of UCD identifiers to a received set of UCD identifiers included in the received aggregate sensor dataset to identify expected UCD identifiers not included within the UCD identifiers. Wherein the expected UCD identifiers match the received UCD identifiers, the NCD may provide a notification indicating the aggregate sensor dataset is successfully received. Wherein the expected UCD identifiers do not match the received UCD identifiers, the NCD may identify an additional coordinator NCD at which the sensor data associated with an unmatched expected UCD identifier is stored.

In at least one aspect, at least a first portion of the plurality of UCDs may comprise a first subnetwork, at least a second portion of the plurality of UCDs may comprise a second subnetwork, and the UCDs of the first and second subnetwork may be configured to communicate with each other. The UCD may be included in the first and second subnetworks.

The NCD may be configured to receive an additional aggregate sensor dataset from an additional coordinator UCD associated with an additional long-range wireless mesh network.

The aggregate sensor dataset may be encrypted and include a customer identifier. The NCD may be configured to identify a decryption key associated with the customer identifier, and decrypt the aggregate sensor dataset using the decryption key.

The system may further include a management platform for providing operational support for the plurality of UCDs and associated portable structures. The management platform may receive the aggregate sensor dataset from the data storage platform, analyze the aggregate sensor dataset to generate analytics for the portable structures, and/or provide one or more support services based at least in part on the analytics.

The management platform may store model data associated with a machine learning model trained using training data. The management platform may execute the machine learning model, such as a machine learning model selected from the group consisting of a predictive analytics model and route optimization model.

Although the techniques disclosed herein are associated with portable structures such as portable toilets, the techniques may be applied to other structures.

As disclosed by the present techniques, any UCD may be designated as a coordinator UCD. Accordingly, the terms “UCD” and “coordinator UCD” may at times be used interchangeably.

As disclosed by the present techniques, sensor data may be aggregated by a coordinator to generate an aggregated sensor dataset. Accordingly, the terms “sensor data” and “aggregated sensor dataset” may at times be used interchangeably.

### Exemplary Computing Environment

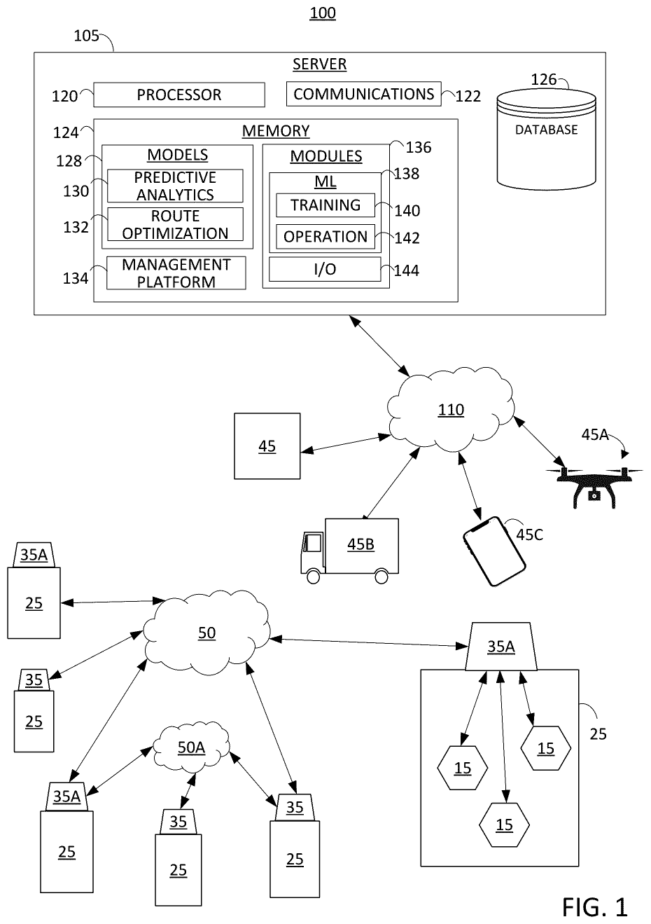

FIG. 1 depicts an exemplary computing environment 100 associated with operating a network of unit collection devices. Although FIG. 1 depicts certain entities, components, equipment, and/or devices, it should be appreciated that additional or alternate entities, components, equipment, and/or devices are envisioned.

As illustrated in FIG. 1, the computing environment 100 may include, in one aspect, a plurality of sensors 15 associated with respective portable structures 25. The sensors 15 may generate sensor data associated with at least one portable structure 25, such as a portable toilet. The sensors 15 may include electrical sensors, mechanical sensors, chemical sensors, image sensors, audio sensors, a combination thereof, and/or any other suitable type of sensor for the particular type of structure 25. The sensor data may indicate and/or include, CMOS data, transducer data, the location (e.g. GPS data) of the portable structure 25, the frequency of use of the portable structure 25, a hygiene level of the portable structure 25 (e.g., based on one or more of cleanliness, a level of waste, odors, etc.), a door lock status of the portable structure 25, a level of a consumable product (e.g., toilet paper, water, soap, paper towels, etc.) of the portable structure 25, a presence of an occupant (e.g., as determined using a thermal sensor) and/or any other suitable sensor data. The sensors 15 of the portable structure 25 may provide their sensor data to a respective UCD 35 associated with the portable structure 25, and/or other suitable devices/components of the computing environment 100, in a wired manner (e.g., via a data bus), a wireless manner (e.g., via Bluetooth), and/or any other suitable manner of providing the sensor data to the UCD 35.

In some embodiments, the sensor data may be used to activate devices, components, and/or communication connections of the computing environment 100, such as one or more long-range communication connections of the UCD 35 and/or the coordinator UCD 35A. In one example, the accelerometer sensor data of the portable structure 25 indicates the associated the portable structure 25 is tipped over. As a result of receiving the sensor data indicating the tip over, the UCD 35 associated with the portable structure 25 may activate the GPS sensor of the portable structure to determine the location of the portable structure 25, and also activate an inactive long-range communication connection (e.g., LTE-M, NB-IoT, satellite) of the UCD 35. The UCD 35 may provide information indicating the tip over event and/or location of the portable structure 25 to the server 105 via the activated long-range communication connection, so the tipped over portable structure 25 can be serviced. In one example, the door lock sensor detects unlocking of the door of the portable structure 25, which results in the activation (e.g., by the associated UCD 35) of an interior thermal sensor that detects the presence of an occupant in the portable structure 25, and activation of consumable product sensors to monitor usage of the consumables by the occupant. The examples just described are for illustrative purposes only, and any suitable devices (e.g., the coordinator UCD 35A, the NCD 45, the server 105) may activate any suitable devices, components, and/or communication connections of the computing environment 100 based upon the sensor data.

The computing environment 100 may include a plurality of UCDs 35 associated with respective structures 25. The UCDs 35 may include a processor, a memory, a communication component, sensors (e.g., the sensors 15), a power supply, and/or other suitable components. The UCDs 35 may be an electronic device configured to receive sensor data from the sensors 15, store the sensor data locally on a memory, provide the sensor data to other UCDs 35 and/or NCDs 45, among other things. In at least one aspect, each UCD 35 may be associated with a respective portable structure 25, e.g., to collect the sensor data from the sensors 15 associated with the portable structure 25, as just described.

The plurality of UCDs 35 may be configured to create at least one long-range wireless mesh network (mesh network) 50, e.g., using their respective communications component, wherein each UCD 35 may operate as a node in the mesh network 50. The mesh network 50 may be a bidirectional mesh network based upon a LoRaWAN protocol. At least a portion of the plurality of UCDs 35 may comprise a subnetwork 50A of the mesh network 50. The UCDs 35 may be configured to communicate with one another via the subnetwork 50A and/or mesh network 50, including communicating with the UCDs 35 of the same or a different subnetwork 50A and/or mesh network 50. For example, the UCDs 35 of a first subnetwork 50A may communicate with one another to share their respective sensor data and/or sensor data of other UCDs 35 which they have received, e.g., to provide the sensor data of all of the UCDs 35 to a respective coordinator UCD 35A.

One or more of the UCDs 35 may operate as the coordinator UCD 35A for at least a portion of the UCDs 35. The coordinator UCD 35A may be designated receive sensor data from the UCDs 35 (e.g., the UCDs 35 in the same subnetwork 50A as the coordinator UCD 35A), and/or share sensor data with other coordinator UCDs 35A, whether part of the same or a different subnetwork 50A or mesh network 50. The coordinator UCD 35A may generate (e.g., using the processor) an aggregate sensor dataset from at least a portion of the sensor data which it has received from the UCDs 35 or other coordinator UCDs 35A, e.g., generate the aggregate sensor dataset of the sensor data of all the UCDs 35 in its subnetwork 50A. In one example, the coordinator UCD 35A of the first subnetwork 50A may transmit the aggregate sensor dataset of the first subnetwork 50A to the coordinator UCD 35A of a second subnetwork 50A; the second coordinator UCD 35A may transmit the aggregate sensor datasets of the first and second subnetworks 50A to the coordinator UCD 35A of a third subnetwork 50A, and so on. The sensor data and/or aggregate sensor dataset may include UCD identifiers associated with the UCDs from which the sensor data is received, time stamps associated with when the sensor data was generated and/or received, and/or any other suitable data. The coordinator UCD 35A may store the aggregate sensor dataset locally on the memory of the coordinator UCD. In at least one aspect, the UCDs 35 (including coordinator UCDs 35A) may have limited storage capacity which limits the amount of sensor data that may be stored. Accordingly, the UCDs 35, such as the coordinator UCD 35A, may store sensor data from at least one other UCD 35, but may not store the sensor data of all the other UCDs 35 in the mesh network 50; rather, just the sensor data of all the other UCDs 35 in the subnetwork 50A.

The communication component of the UCDs 35 may be configured to communicate via one or more communication types, mediums, protocols, methods, standards, connections, networks, and/or other suitable communication technologies, such as such as Bluetooth, Wi-Fi direct, near-field communication (NFC), ultra-wideband (UWB), a wide-area network (WAN), LoRaWAN, long-term evolution machine type communication (LTE-M/LTE-MTC), narrowband internet-of-things (NB-IoT), satellite communication (e.g., low-earth orbit, high-earth orbit), and/or any other suitable communication technology. In some embodiments, the UCDs 35 communication component may provide short-range communication connections (e.g., Bluetooth, Wi-fi direct, NFC, UWB) to provide the sensor data to the NCD 45, and long-range LoRaWAN communication connections to form the mesh network 50. However, the UCDs 35 may include other communication connections, and/or other communication connections may be added/activated. In one aspect, the communications component may be configured (e.g., via activation of existing hardware, or the addition of new hardware) with additional long-range communications connection to allow the UCD 35, such as the coordinator UCD 35A, to provide the aggregate sensor dataset to the data storage platform, rather than requiring the NCD 45 to collect the aggregate sensor dataset and provide it to the data storage platform. The UCD 35 and/or the coordinator UCD 35A may include other functionality generally associated with the NCD 45, as further described below.

In some embodiments, one or more UCDs 35 may have different communication connections than other UCDs 35. In at least some aspects, not all the communication connections may always be active. In one example, one coordinator UCD 35A may include and/or have activated satellite communications based upon its remote location outside of LTE-M communication range, whereas other UCDs 35 of the same mesh network may not include/have activated satellite communication based upon being within LTE-M communication range. In some embodiments, at least some of the functionality of the communications component may be fee-based, e.g., for a monthly subscription fee, the satellite communication connection is activated, otherwise the satellite communication connection is inactive. In some embodiments, at least some of the functionality of the communication component may be activated based upon the sensor data, as previously described. For example, the communication component of the coordinator UCD 35A may be inactive to save power, but upon receiving a sensor data indicating the respective portable structure 25 is tipped over or otherwise moving, a long-range communication connection (e.g., LTE-M) of the communication component is activated to permit sending a transmission regarding the tip over from the coordinator UCD 35A to the server 105.

In some embodiments, the coordinator UCD 35A may not be the UCD 35. In one aspect, the coordinator UCD 35A may be a base station used to generate aggregate sensor dataset received from the UCDs 35 within the mesh subnetwork 50A, and/or provide the aggregate sensor dataset to the another device/component of the computing environment 100, such as the storage platform of server 105. For example, a network of UCDs 35 located in a remote, hard-to-reach area, may have only have LoRaWAN long-range communication connections to form the mesh subnetwork 50A. Due to the remote location of the group of the UCDs 35, it may be difficult to have the NCD 45 travel to the network of UCDs 35 to collect the aggregate sensor dataset from the mesh subnetwork 50A. Rather than upgrade the communication connections of the UCDs 35 in the mesh subnetwork 50A, e.g., via purchasing and installing new long-range communication hardware at the remote location so the UCDs 35 may provide the sensor data directly to the data storage platform such as server 105, a single base station may be added to the mesh subnetwork 50A to act as the coordinator UCD 35A. The base station may collect sensor data to generate the aggregate sensor dataset, and provide the aggregate sensor dataset to the storage platform of the server 105.

In some embodiments, the communications component of the UCDs 35, the coordinator UCDs, and/or the NCDs 45 may be configured using artificial intelligence (e.g., machine learning), for example to optimize operation of the communication component. In one aspect, the server 105 provides the artificial intelligence as one or more algorithms, models, programs, etc., in communication with the UCDs 35, the coordinator UCDs, and/or the NCDs 45 via the network 110. In one example, the artificial intelligence may configure the communication component to communicate using LoRaWAN rather than satellite for power efficiency. In one example, the artificial intelligence may configure the communication component to be activated or deactivated according to a schedule to save power. In one example, the artificial intelligence may configure the communication component based upon the type of data to communicate (e.g., kilobytes of chemical sensor data transmitted using a lower-bandwidth connection versus megabytes of video data transmitted using a higher-bandwidth connection), the recipient of the data (e.g., another UCD 35 within a ten feet, the NCD 45 within hundreds of feet, or a remote server miles away). The artificial intelligence may configure the communication component in any other suitable manner.

It should be appreciated that in many networks, the UCDs 35 are located in remote areas with poor network connectivity. That is, the network operator may not be able to rely on cellular data network (such as a 3G, 4G, 5G, 6G, etc. data network) or a Wi-Fi communication network to obtain the sensor data from the UCDs 35. Accordingly, the network operator may need to physically travel proximate to the site at which the UCDs 35 are located to actually be able to receive the sensor data to perform the further processing techniques described herein.

The computing environment 100 may include at least one NCD 45. The NCD 45 may include a processor, a memory, a communication component, sensors, a power supply, and/or other suitable components. The NCD 45 may be configured to communicate with the UCDs 35 and/or the coordinator UCDs 35A, for example to automatically collect the aggregate sensor dataset from the coordinator UCD 35A via the communications components when in range of the coordinator UCD 35A. The NCD 45 may provide the aggregate sensor dataset to a storage platform, such as storage on the server 105, local storage (e.g., a local memory), and/or any other suitable storage platform.

In at least one aspect, the NCD 45 may be, or be part of, a vehicle (e.g., a drone 45A or a vehicle 45B which travels to the coordinator UCDs 35A), a mobile device 45C (e.g., a smartphone of a technician collecting the aggregate sensor datasets), and/or any other suitable mobile computing system. The NCD 45 may wirelessly collect the aggregate sensor dataset via a direct communication coupling with the coordinator UCD 35A, e.g., via Bluetooth, Wi-Fi direct, near-field communication (NFC), ultra-wideband (UWB), a LoRaWAN-based communication, etc., and/or collect the aggregate sensor dataset in any other suitable manner. The NCD 45 may collect from the coordinator UCD 35A at least a portion of the aggregate sensor dataset of the coordinator UCD 35A. In one example, the NCD 45 may have limited storage capacity, such that it may only be able to collect some of the aggregate sensor dataset of one or more coordinator UCDs 35A. In one example, the NCD 45 may have recently collected the aggregate sensor dataset from the coordinator UCD 35A, such that the NCD 45 only needs to collect the portion of the aggregate sensor dataset which was generated since the last collection (e.g., as indicated by timestamps in the aggregate sensor dataset). In at least one aspect, the aggregate sensor dataset may be encrypted and associated with a customer identifier. The NCD 45 may be configured to obtain a decryption key associated with the customer identifier of the aggregate sensor dataset (assuming the NCD 45 has sufficient permissions), and decrypt the aggregate sensor dataset using the decryption key.

In at least one aspect, the NCD 45 may be able to provide data to the UCD 35, for example to reprogram or update the UCD 35 to change the manner in which the UCD 35 collects the sensor data from the sensors 15, and/or provides the sensor data to other UCDs 35 or coordinator UCDs 35A. In at least one aspect, the NCD 45 may generate data, such as data associated with collecting the aggregate sensor dataset from the coordinator UCDs 35A (e.g., time of collection, location of collection, amount of data collected, route traveled to collect the data, etc.).

The computing environment 100 may include at least one server 105 which may perform the at least some of the functionalities and techniques disclosed, such as operating a network of unit collection devices. The server 105 may be part of a cloud network or may otherwise communicate with other hardware or software components within one or more cloud computing environments to send, retrieve, or otherwise analyze data or information described herein. In one example, in certain aspects of the present techniques, the computing environment 100 may comprise an on-premise computing environment, a multi-cloud computing environment, a public cloud computing environment, a private cloud computing environment, and/or a hybrid cloud computing environment. In one example, an entity (e.g., a business providing APIs for its software applications) may host one or more services in a public cloud computing environment (e.g., Amazon Web Services (AWS), Google Cloud, IBM Cloud, Microsoft Azure, etc.). The public cloud computing environment may be a traditional off-premise cloud (i.e., not physically hosted at a location owned/controlled by the business). Alternatively, or in addition, aspects of the public cloud may be hosted on-premise at a location owned/controlled by the business. The public cloud may be partitioned using visualization and multi-tenancy techniques and/or may include one or more of software-as-a-service (SaaS), infrastructure-as-a-service (IaaS) and/or platform-as-a-service (PaaS).

The computing environment 100 may include a network 110 comprising any suitable network or networks, including a local area network (LAN), wide area network (WAN), Internet, or combination thereof. For example, the network 110 may include a wireless cellular service (e.g., 4G service, 5G service, 6G service, etc.). Generally, the network 110 enables bidirectional communication between the server 105 and the NCDs 45. In one aspect, the network 110 may comprise a cellular base station, such as cell tower(s), communicating to the one or more components of the computing environment 100 via wired/wireless communications based upon any one or more of various mobile phone standards, including NMT, GSM, CDMA, UMTS, LTE, 5G, 6G, or the like. Additionally, or alternatively, the network 110 may comprise one or more routers, wireless switches, or other such wireless connection points communicating to the components of the computing environment 100 via wireless communications based upon any one or more of various wireless standards, including by non-limiting example, IEEE 802.11 a/ac/ax/b/c/g/n (Wi-Fi), Bluetooth, and/or the like.

A communications component 122 may allow the server 105 to communicate over the network 110 via any suitable wired and/or wireless connection, e.g., using any suitable network interface controller(s) of the communications component 122. The communications component 122 may include one or more transceivers (e.g., WWAN, WLAN, and/or WPAN transceivers) functioning in accordance with IEEE reference standards, 3GPP reference standards, and/or other reference standards that may be used in receipt and transmission of data via external/network ports of the server 105 connected to computer network 110.

The server 105 may include at least one processor 120. The processor 120 may include one or more suitable processors (e.g., central processing units (CPUs) and/or graphics processing units (GPUs)). The processor 120 may be communicatively coupled to a memory 124 via a computer bus (not depicted) responsible for transmitting electronic data, data packets, or otherwise electronic signals to and from the processor 120 and the memory 124 in order to execute, implement or perform the machine-readable instructions, methods, processes, elements, or limitations, as illustrated, depicted, or described for the various flowcharts, illustrations, diagrams, figures, and/or other disclosure herein. The processor 120 may interface with the memory 124 via the computer bus to execute an operating system and/or computing instructions contained therein, and/or to access other services/aspects. For example, the processor 120 may interface with the memory 124 via the computer bus to create, read, update, delete, or otherwise access or interact with the data stored in the memory 124, database 126, and/or another source of data.

The memory 124 may include one or more forms of volatile and/or nonvolatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. The memory 124 may store an operating system (e.g., Microsoft Windows, Linux, UNIX, etc.) capable of facilitating the functionalities, apps, methods, or other software as described herein. The memory 124 may store one or more sets of non-transitory, computer-executable instructions that, when executed, cause the server 105 to perform certain functions.

In general, a computer program or computer based product, application, or code (e.g., the model(s), such as ML models, or other computing instructions described herein) may be stored on a computer usable storage medium, or tangible, non-transitory computer-readable medium (e.g., reference random access memory (RAM), an optical disc, a universal serial bus (USB) drive, or the like) having such computer-readable program code or computer instructions embodied therein, wherein the computer-readable program code or computer instructions may be installed on or otherwise adapted to be executed by the processor(s) 120 (e.g., working in connection with the respective operating system in the memory 124) to facilitate, implement, or perform the machine readable instructions, methods, processes, elements or limitations, as illustrated, depicted, or described for the various flowcharts, illustrations, diagrams, figures, and/or other disclosure herein. In this regard, the program code may be implemented in any desired program language, and may be implemented as machine code, assembly code, byte code, interpretable source code or the like (e.g., via Golang, Python, C, C++, C#, Objective C, Java, Scala, ActionScript, JavaScript, HTML, CSS, XML, etc.).

The server 105 may include, or be communicatively coupled to (e.g., via network 110), at least one electronic database 126. The database 126 may include a relational database, such as Oracle, DB2, MySQL, a NoSQL database, such as MongoDB, or another electronic database. The database 126 may include various types of data associated with operating a network of unit collection devices, such as sensor data, aggregate sensor datasets, management platform data (e.g., user account data, analytics data, etc.), and/or any other suitable type of data. In some aspects, the database 126 may be the storage platform for the aggregate sensor datasets.

The memory 124 and/or the database 126 may store one or more models, routines, algorithms, or other elements. The models may include one or more ML models 128. The ML models 128 may be referred to as receiving an input, producing or storing an output, or executing as instructions by the processor 120. Further, the ML models 128 may be stored in the memory 124 and/or the database 126 as computer-executable instructions, which instructions the processor 120 may access and execute. Further, the processor 120 should be understood to retrieve/access from the memory 124 and/or the database 126 any data necessary to perform the executed instructions (e.g., data required as an input to the routine or model), and to store in the memory 124 and/or the database 126 the intermediate results and/or output of any executed instructions.

In at least one aspect, the ML models 128 may include a predictive analytics ML model 130 trained using predictive analytics training data to generate predictive analytics for the portable structures 25 based upon receiving one or more aggregate sensor datasets and/or other suitable data. The predictive analytics may include information such as predicted traffic at, and/or usage of, the portable structure 25, predicted level of consumables (e.g., water, soap, paper towels, toilet paper, etc.) of the portable structure 25, predicted cleanliness of the portable structure 25, and/or any other suitable predictive analytic associated with the portable structure 25. The predictive analytics training data may include historical sensor data (e.g., historical aggregate sensor datasets) indicating historical usage of historical portable structures, such as historical consumable levels, the time and/or date of historical usage, the weather during the historical usage, historical locations of the historical portable structures, among other things.

In at least one aspect, the ML models 128 may include a route optimization ML model 132 trained using route optimization training data to generate one or more optimal routes to collect (e.g., by the NCD 45) the aggregate sensor data, based upon receiving one or more aggregate sensor datasets and/or other suitable data. The optimized route may include one or more maps, directions (e.g., driving directions for terrestrial vehicles, flight directions for airborne vehicles), estimated travel times, locations of UCDs, data collection parameters (e.g., how much data to collect from the coordinator UCDs 35A, how often to collect the aggregate sensor datasets), and/or any other suitable information associated with an optimal route. The route optimization training data may include historical optimized routes, historical maps, historical directions, historical estimated travel times, historical locations of UCDs, etc.

The memory 124 and/or the database 126 may store one or more sets of training data. The training data may include testing, validation, feedback, and/or other training data which may be used to create, operate, (re) train and/or fine-tune one or more ML models, such as the ML models 128, the predictive analytics ML model 130, and/or the route optimization ML model 132, as further described herein.

The memory 124 may include a management platform application (management platform) 134 stored as processor-executable instructions. The management platform 134 may provide operational support for the UCDs 35 (including the coordinator UCDs 35A), the NCDs 45, and/or the portable structures 25. In at least one aspect, the management platform 134 may include, and/or execute, the predictive analytics ML model 130 and/or the route optimization ML model 132. In one aspect, the management platform 134 may receive the aggregate sensor dataset from the data storage platform, analyze the aggregate sensor dataset to generate customer usage data, service data, analytics, and/or other suitable data/information for the portable structures 25 associated with the plurality of UCDs 35. In one aspect, the management platform 134 may generate data which is not based upon the sensor data, such as generating information associated with the costs of manual labor to operate and maintain the UCDs 35. The data, such as the analytics, may include, data, graphs, charts, tables, notifications, advertisements, images/audio/video (e.g., of the portable structure 25), maps (e.g., of the locations of the portable structures 25), and/or any other suitable information. The management platform 134 may use artificial intelligence and/or machine learning to generate the data, such as the predictive analytics ML model 130, although artificial intelligence and/or machine learning is not required. In one example, the management platform 134 generates data associated with water of the portable structure 25, and/or a vehicle providing water to the portable structure 25, such as water tank level, water flow, water evaporation rate (e.g., based upon temperature, humidity, pressure, gas resistance, etc.), water freshness, and/or water temperature (e.g., freeze detection of the water tank). In one example, the data may be associated with the interior of the portable structure 25, such as odor (e.g., detection, strength), effectiveness of chemicals (e.g., disinfectants, water treatment chemicals), and/or occupancy detection (e.g., presence of an occupant, identity of the occupant such as service technician). In one example, the data may include customer satisfaction information, (predicted) operating costs (e.g., fuel for the NCD 45, labor to maintain the portable structure 25, consumables), and/or any other suitable data. The management platform may provide the data via a user interface (e.g., a dashboard accessible via the internet), to a user device via a mobile application, via an electronic communication (e.g., email, text message, alert), and/or in any other suitable manner.

The management platform 134 may provide one or more support services based at least in part on the analytics. In one example, the management platform 134 may generate collection data associated with data collection parameters by the NCD 45, and provide the collection data to the NCD 45 (e.g., via network 110). In one example, the management platform 134 may generate and provide one or more notifications to the NCD 45, or other suitable device(s)/component(s) of the computing environment 100, such as a notification to service the portable structure 25. In one example, the management platform 134 may generate data associated with reprogramming and/or reconfiguring the UCD 35 and/or the coordinator UCDs 35A, and provide the data to the NCD 45 (e.g., via network 110) to provide to the UCD 35 and/or the coordinator UCDs 35A when in communication range. In one embodiment, the management platform 134 may receive and/or access aggregate sensor data stored in a storage platform, such as the database 126.

The memory 124 may store a plurality of computing modules 136, implemented as respective sets of computer-executable instructions (e.g., one or more source code libraries, trained ML models such as a neural network, a convolutional neural network, etc.) as described herein. Although depicted in FIG. 1 as part of memory 124, the ML models 128, the predictive analytics ML model 130, and/or the route optimization ML model 132 may be considered as one or more computing modules 136.

The computing modules 136 may include an ML module 138. The ML module 138 may include ML training module (MLTM) 140 and/or ML operation module (MLOM) 142. In some embodiments, at least one of the ML models 128 may be applied by the ML module 138, which may include, but are not limited to linear or logistic regression algorithms, instance-based algorithms, regularization algorithms, decision trees, Bayesian networks, cluster analysis, association rule learning, artificial neural networks, deep learning, combined learning, reinforced learning, dimensionality reduction, and support vector machines. In various embodiments, the implemented ML methods and algorithms are directed toward at least one of a plurality of categorizations of ML, such as supervised learning, unsupervised learning, and reinforcement learning. In one aspect, the ML based algorithms may be included as a library or package executed on server(s) 105. For example, libraries may include the TensorFlow based library, the Pytorch library, and/or the scikit learn Python library.

In one embodiment, the ML module 138 employs supervised learning, which involves identifying patterns in existing data to make predictions about subsequently received data. Specifically, the ML module is “trained” (e.g., via MLTM 140) using the training data, which includes exemplary inputs and associated exemplary outputs. Based upon the training data, the ML module 138 may generate a predictive function which maps outputs to inputs and may utilize the predictive function to generate ML outputs based upon data inputs. The exemplary inputs and exemplary outputs of the training data may include any of the data inputs or ML outputs described herein. In the exemplary embodiments, a processing element may be trained by providing it with a large sample of data with known characteristics or features.

In another embodiment, the ML module 138 may employ unsupervised learning, which involves finding meaningful relationships in unstructured data. Unlike supervised learning, unsupervised learning does not involve user-initiated training based upon exemplary inputs with associated outputs. Rather, in unsupervised learning, the ML module 138 may organize unlabeled data according to a relationship determined by at least one ML method/algorithm employed by the ML module 138. Unorganized data may include any combination of data inputs and/or ML outputs as described above.

In yet another embodiment, the ML module 138 may employ reinforcement learning, which involves optimizing outputs based upon feedback from a reward signal. Specifically, the ML module 138 may receive a user-defined reward signal definition, receive a data input, utilize a decision-making model to generate the ML output based upon the data input, receive a reward signal based upon the reward signal definition and the ML output, and alter the decision making model so as to receive a stronger reward signal for subsequently generated ML outputs. Other types of ML may also be employed, including deep or combined learning techniques.

The MLTM 140 may receive labeled data at an input layer of a model having a networked layer architecture (e.g., an artificial neural network, a convolutional neural network, etc.) for training the one or more ML models 128. The received data may be propagated through one or more connected deep layers of the ML model 128 to establish weights of one or more nodes, or neurons, of the respective layers. Initially, the weights may be initialized to random values, and one or more suitable activation functions may be chosen for the training process. The present techniques may include training a respective output layer of the one or more ML models 128.

The MLOM 142 may comprise a set of computer-executable instructions implementing ML loading, configuration, initialization and/or operation functionality. The MLOM 142 may include instructions for storing trained ML models (e.g., as the ML models 128 in the memory 124). As described, once trained, the one or more trained ML models 128 may be operated in inference mode, whereupon when provided with de novo input that the model has not previously been provided, the model may output one or more predictions, classifications, etc., as described herein.

In operation, the MLTM 140 may access the memory 124, the database 126, and/or any other data source for training data (e.g., training data) suitable to generate one or more ML models, such as the ML models 128. The training data may be sample data with assigned relevant and comprehensive labels (classes or tags) used to fit the parameters (weights) of the ML model 128 with the goal of training it by example. In one aspect, once an appropriate ML model 128 is trained and validated to provide accurate predictions and/or responses, the trained ML model 128 may be loaded into the MLOM 142 at runtime to process input data and generate output data.

While various embodiments, examples, and/or aspects disclosed herein may include training and generating the ML models 128 for the server 105 to load at runtime, one or more appropriately trained ML models may already exist (e.g., the ML models 128 in the memory 124, ML models stored on a database accessible via network 110, etc.) such that the server 105 may load the existing trained ML model 128 at runtime. The server 105 may retrain, fine-tune, update and/or otherwise alter an existing ML model 128 before and/or after loading the ML model 128 at runtime. Although the ML model 128 is described as being trained (e.g., via MLTM 140) and operated (e.g., via MLOM 142) on the server 105, in at least one embodiment the ML model 128 may be trained on one server 105, and operated on another server 105.

In one aspect, the computing modules 136 may include an input/output (I/O) module 144, comprising a set of computer executable instructions implementing communication functions. The I/O module 144 may include a communication component configured to communicate (e.g., send and receive) data via one or more external/network port(s) to one or more networks or local terminals, such as the network 110 described herein. In one aspect, the server 105 may include a client-server platform technology such as ASP.NET, Java J2EE, Ruby on Rails, Node.js, a web service or online API, responsive for receiving and responding to electronic requests.

The I/O module 144 may further include or implement a user interface configured to present information to an administrator, operator or other user, and/or receive inputs from the user, such as via a touchscreen display. The I/O module 144 may facilitate I/O components (e.g., ports, capacitive or resistive touch sensitive input panels, keys, buttons, lights, LEDs), which may be directly accessible via, or attached to, the server 105 and/or may be indirectly accessible via, or attached to, another device. According to one aspect, a user may access the server 105 via a user interface to review information, make changes, input training data, initiate training via the MLTM 140, and/or perform other functions (e.g., operation of one or more trained models via the MLOM 142).

In one example, the computing environment 100 may operate a network of UCDs 35 for portable structures, such as portable toilets, of remote campsites located across a state. The UCDs 35 of all the campsite locations may form the mesh network 50 across the state, and the UCDs 35 of each campsite may form the subnetwork 50A. Each UCD 35 may be associated with the portable structures 25 at each campsite location, and may receive sensor data from the sensors 15 associated with their respective portable structure 25. The sensor data may indicate the status of the respective portable structure 25, e.g., whether it is occupied, the air quality, the level of consumables, the level of waste, etc. While the remote campsite example is used below, it should be appreciated that customers may operate a network of UCDs 35 for portable structures 25 across a variety of different properties. For example, a drilling or oil company may have a network of portable structures 25 at different drill sites, an agricultural company may have portable structures 25 across different farm sites, and so on.

One UCD 35 at each campsite location may be designated as the coordinator UCD 35A, such that there is one coordinator UCD 35A for each of the subnetworks 50A. The UCDs 35 at each campsite location may provide their sensor data to the coordinator UCD 35A of their respective subnetwork 50A, e.g., by sending the sensor data directly to the coordinator UCD 35A or indirectly via other UCDs 35 in the mesh network 50 or subnetwork 50A. Each coordinator UCD 35A may generate an aggregate sensor dataset of the sensor data received from the UCDs 35 within their subnetwork 50A, i.e., an aggregate sensor dataset for each campsite location. Each UCD 35 may associate an identifier associated with the UCD 35 with the set of sensor data received thereat such that the source of the sensor data can be tracked. Accordingly, each aggregate sensor dataset may include UCD identifiers which identify all the UCDs of that campsite location (or, in some embodiments, subnetwork thereof). The coordinator UCDs 35A may store their respective aggregate sensor dataset, e.g., locally on a memory of the coordinator UCD 35A.

The NCD 45 may travel to the collector UCD 35A of each campsite location to collect the aggregate sensor dataset of each campsite location. For example, a vehicle including the NCD 45B may drive along a route provided by the management platform 134 to the coordinator UCD 35A at each campsite location; a drone including the NCD 45A may fly along a route provided by the management platform 134 to the coordinator UCD 35A at each campsite location; a technician for the portable structures 25 may visit the coordinator UCD 35A of each campsite location with a mobile device NCD 45C, etc. In at least one aspect, the vehicle NCD 45B, the drone NCD 45A and the mobile device NCD 45C may each collect the aggregate sensor dataset from a different campsite location, such that collectively the vehicle NCD 45B, the drone NCD 45A, and the mobile device NCD 45C collect the aggregate sensor datasets from all the campsites in the state. In response to the NCD 45 being within wireless communication range of the coordinator UCD 35A, the NCD 45 may receive the aggregate sensor dataset from the coordinator UCD 35A for the respective campsite location. In some embodiments, the NCD 45 and the coordinator UCD 35A may use a short-range network protocol to exchange the aggregate sensor dataset, such as Bluetooth. For example, a drone NCD 45A may hover near the coordinator UCD 35A at each campsite of the state to collect the aggregate sensor datasets for all the campsite locations. In some embodiments, the NCD 45 may be configured as a node of the network 50 (or subnetwork 50A) such that the UCD 35A automatically transmits the aggregate dataset when the NCD 45 is in signal range of the UCD 35A. For example, the NCD 45 may be configured as a coordinator node such that the mesh networking rules for transmission of the sensor data cause the UCD 35A to transmit the aggregate sensor dataset to the NCD 45. In at least one aspect, the NCD 45 may transmit data to one or more UCDs 35 or coordinator UCDs 35A, such as data to reconfigure the data schedule for transmitting data form the UCDs 35 of the subnetwork 50A to the coordinator UCD 35A.

In at least one aspect, the NCD 45 may obtain (e.g., from the server 105, the management platform 134), for the mesh network 50, an expected set of UCD identifiers associated with UCDs 35 expected to have sensor data included in the aggregate sensor datasets. The NCD 45 may compare the expected set of UCD identifiers to a received set of UCD identifiers included in the received aggregate sensor datasets to identify expected UCD identifiers not included within the received set of UCD identifiers. When the expected UCD identifiers match the received UCD identifiers, the NCD 45 may generate a notification (e.g., audio notification via a speaker of the NCD 45, visual notification via a display of the NCD 45, etc.) indicating the aggregate sensor datasets are successfully received and/or all expected UCD identifiers are accounted for in the collected aggregate sensor datasets. When the expected UCD identifiers do not match the received set of UCD identifiers, the NCD 45 may identify one or more additional coordinator UCDs 35A storing the sensor data associated with one or more unmatched expected UCD identifiers. For example, the NCD 45 may receive a data file from the management platform 134 of the server 105 via the network 110 which includes the UCD identifiers of all the UCDs 35 of the mesh network 50 of the campsite locations. The NCD 45 may visit a first coordinator UCD 35A of the first subnetwork 50A of a first campsite location to receive a first aggregate sensor dataset from the first coordinator UCD 35A. The NCD 45 may compare the UCD identifiers of the first aggregate sensor dataset to the UCD identifiers of the data file. The NCD 45 may generate a notification instructing a technician to travel to a second coordinator UCD 35A of a second subnetwork 50A to collect a second aggregate sensor dataset. The notification may include directions to the coordinator UCD 35A. The NCD 45 may similarly travel to the second coordinator UCD 35A, collect the second aggregate sensor dataset when in communication range of the second coordinator UCD 35A, and compare the UCD identifiers of the second aggregate sensor dataset to the UCD identifiers of the data file. The NCD 45 may generate another notification with directions instructing the technician to travel to a third coordinator UCD 35A of the third subnetwork 50A to collect a third aggregate sensor dataset. The NCD 45 may similarly travel to the third coordinator UCD 35A, collect the third aggregate sensor dataset when in communication range of the third coordinator UCD 35A, and compare the UCD identifiers of the third aggregate sensor dataset to the UCD identifiers of the data file. Based upon the comparison, the NCD 45 may generate an audiovisual notification indicting that sensor data has been collected from all the UCDs 35 associated with the expected UCD identifiers of the data file, and that no further aggregate sensor datasets need to be collected.

In at least one aspect, the sensor data and/or the aggregate sensor datasets may be encrypted. The UCDs 35 and/or the NCD 45 may be associated with a customer identifier, e.g., a customer identifier which the NCD 45 may be able to read or otherwise obtain, e.g., without decrypting the encrypted data. The NCD 45 may be able to decrypt the encrypted data using a decryption key associated with the customer identifier. In at least some aspects, the UCDs 35 and/or the coordinator UCDs 35A may be able to decrypt the encrypted data, for example when the coordinator UCD 35A is a base station for a mesh subnetwork 50A that does not have the NCD 45 and/or the base station is configured to have at least some of the functionality of the NCD 45.

In one example, a first customer of the disclosed systems may operate a NCD 45 within signal range of a coordinator UCD 35A of a second customer the disclosed systems. Accordingly, the NCD 45 may surreptitiously collect aggregate sensor datasets associated with the second customer. However, because the NCD 45 does not have access to the decryption key associated with the second customer, the first customer cannot decrypt the collected sensor data.

As another example, the first customer may subcontract the collection of the sensor data from the UCDs 35 to a third party. Accordingly, the first customer may not want to permit the NCD 45 to decrypt the sensor data. In this example, the decryption key may be maintained at the server 105 such that the NCDs 45 cannot view the collected sensor data. In some scenarios, this may permit the third-party data collector to collect data from multiple customers without compromising the data security of the serviced customers. For instance, the coordinator UCD 35A of one of the campsites may be in communication range of a coordinator UCD 35A of a stadium. The coordinator UCD 35A of the campsite may receive a stadium aggregate sensor dataset from the coordinator UCD 35A of the stadium. The stadium aggregate sensor dataset may include an identifier for the stadium. When in range of the coordinator UCD 35A of the campsite, the NCD 45 may receive the aggregate sensor dataset of the campsite and the stadium aggregate sensor dataset. The NCD 45 may identify a decryption key associated with the customer identifier of the campsite, and decrypt the aggregate sensor dataset of the campsite using the campsite decryption key. The NCD 45 may not have a decryption key associated with the customer identifier of the stadium, such that it cannot decrypt the stadium aggregate sensors dataset. However, the NCD 45 may still be able to collect, store, transmit, and/or transfer the encrypted stadium aggregate sensor dataset without decrypting it. This allows the NCD 45 for one entity (e.g., the campsite) to collect, transmit (e.g., to the storage platform), etc., the aggregate sensor dataset of a second entity (e.g., stadium) without being able to read the aggregate sensor datasets of a second entity. This may provide for more efficient collection and/or transfer of aggregate sensor datasets as compared to only being able to collect aggregate sensor datasets for which the NCD 45 has a decryption key. The NCD 45 may provide the aggregate sensor dataset to a data storage platform, such as the server 105, via network 110.

In some aspects, the UCDs 35 and/or coordinator UCDs 35A may provide at least some of the functionality of the NCD 45, such that the NCD 45 may not be required to provide the aggregate sensor dataset to the storage platform. For example, the coordinator UCD 35A may include communication connections (e.g., subscription-based long-range communication, long-range communication from add-on hardware) which allow it to transmit the aggregate sensor data to the data storage platform, eliminating the need for the NCD 45.

The management platform 134 may receive the aggregate sensor dataset from the data storage platform. In at least one aspect, the management platform 134 may be, and/or include, the data storage platform, and in at least another aspect, the data storage platform and the management platform 134 may operate on separate devices, such as a data storage platform server and a management platform server. For example, the server 105 may receive the aggregate sensor dataset from the NCD 45, store the aggregate sensor dataset in the database 126 (e.g., the storage platform), and provide the aggregate sensor dataset to the management platform 134.

The management platform 134 may analyze the aggregate sensor dataset to generate analytics for the portable structures 25 associated with the UCDs 35 of the aggregate sensor dataset, such as analytics associated with use, cleanliness, maintenance, etc., of the portable structures 25. The management platform 134 may provide other analytics which are not based entirely upon the aggregate sensor dataset, e.g., analytics associated with costs to operate the network of portable structures 25.

The management platform 134 may provide one or more support services based at least in part on the analytics. For example, the analytics for portable structures 25 at a first location may indicate that several portable structures 25 require a refill of toilet paper. The management platform 134 may generate information associated with the analytics to an online dashboard for a user account associated with the customer, so that the customer may view the dashboard and alert service staff to refill the toilet paper in the associated portable structures 25.

The management platform 134 may be able to generate notifications associated with the analytics, and provide the notification to an electronic device, such as the NCD 45 or a customer computing device. For example, the analytics may indicate two portable toilets 25 at a particular location need to have their waste reservoirs drained. The management platform 134 may generate an associated notification, and provide the notification via network 110 to the NCD 45 of the nearest technician in the area who can drain the waste reservoirs. The notification may identify the location of the portable structures 25 and directions to their location. The management platform 134 may be able to provide any other suitable support services associated with analytics, e.g., payment for use of the portable structures 25, consumables ordering, service and repair of the portable structures 25, etc.

In at least one aspect, the management platform 134 may store model data associated with one or more ML models trained using training data, and may execute the ML models (e.g., ML models 128). This may include the predictive analytics ML model 130 and/or route optimization ML model 132. For example, the customer may pay the portable toilet company operating the customer's network of UCDs 35 for predictive analytics for the customer's portable toilets 25. The predictive analytics may be provided to an online user account for the campsite via the management platform 134. The predictive analytics ML model 130 may receive the aggregate sensor datasets for the customer's network of portable structures 25 to generate predictive analytics for the network of portable structures 25. The predictive analytics may predict consumable usage for the portable structures 25 at each location for the upcoming month. The management platform 134 may also allow the customer to purchase, via the management platform 134, consumables the portable structures 25, such as the predicted amount of consumables for the next month.

In one example, the management platform 134 may generate an optimized route using the route optimization ML model 132. For example, the route optimization ML model 132 may receive aggregate sensor datasets which indicate that portable toilets at four different locations need servicing by a technician. The route optimization ML model 132 may generate the optimal travel route to the locations for the technician to travel. The management platform 134 may generate directions associated with the optimal travel route and transmit the directions via the network 110 to the NCD 45 of the technician.

Although the computing environment 100 is shown to include one server 105, one network 110, one long-range mesh network 50, one subnetwork 50A, and three NCDs 45, it should be understood that different numbers of servers 105, networks 110, long-range mesh networks 50, subnetworks 50A, NCDs 45, or any other component of the computing environment 100, may be utilized. In one example, the computing environment 100 may include hundreds of UCDs 35, tens of long-range wireless mesh networks 50, and dozens of subnetworks 50A.

The computing environment 100 may include additional, fewer, and/or alternate components, and may be configured to perform additional, fewer, or alternate actions, including components/actions described herein. For example, although the server 105 is shown in FIG. 1 as including one instance of various components such as the processor 120, the memory 124 and the database 126, various aspects include the computing environment 100 and/or the server 105 implementing any suitable number of any of the components shown in FIG. 1 and/or omitting any suitable ones of the components shown in FIG. 1. For instance, information described as being stored in the memory 124 may be stored in the database 126, and therefore the memory 124 may be omitted. Moreover, various aspects include the computing environment 100 having any suitable number of additional component(s) not shown in FIG. 1, such as, but not limited to, the exemplary components described above. Furthermore, it should be appreciated that additional and/or alternative connections between components shown in FIG. 1 may be implemented. As just one example, server 105 may be connected to database 126 via network 110 rather than maintaining the database 126 locally, as illustrated in FIG. 1.

### Exemplary NCD Device

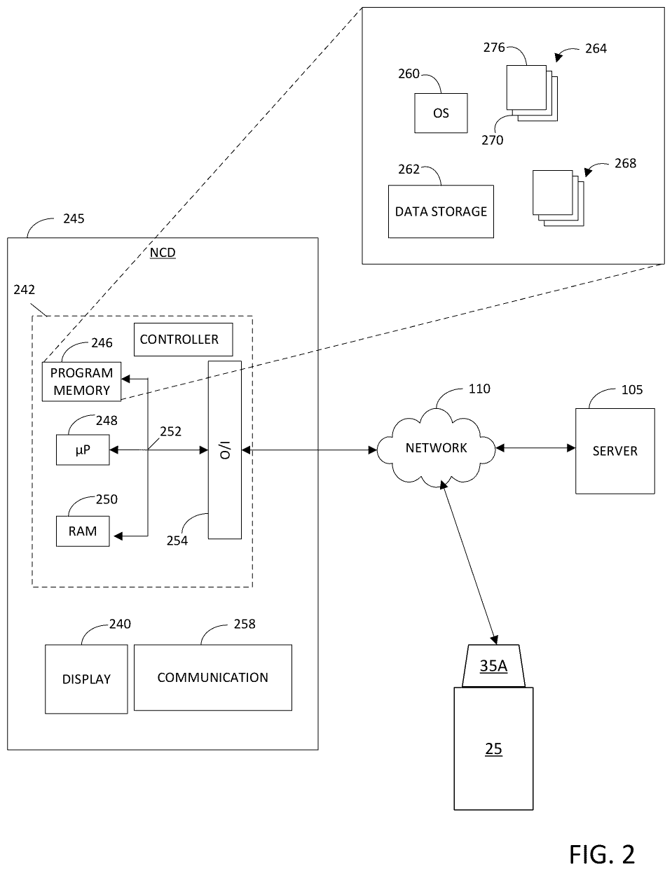

FIG. 2 depicts an exemplary NCD 245, such as the NCD 45. In at least one aspect, the NCD 245 may be and/or include a mobile device, smartphone, a laptop, a handheld electronic device, a drone, an unmanned arial vehicle, a “blackbox” computing device (such as a computing device that has no display screen or user-facing interfaces), and/or any other suitable device to collect, receive, decrypt, provide, and/or otherwise process aggregate sensor datasets.

The NCD 245 may include a display 240, a communication component 258, a user-input device (not shown), and a controller 242. The controller 242 may include a program memory 246, a microcontroller/processor/microprocessor (μP) 248 such as the processor 120, a random-access memory (RAM) 250, and/or an input/output (I/O) circuit 254, all of which may be interconnected via an address/data bus 252. The program memory 246 may include an operating system 260, a data storage 262, a plurality of software applications 264, and/or a plurality of software routines 268. The operating system 260, for example, may include one of a plurality of platforms such as the MacOS or iOS by Apple, Windows or Windows Mobile by Microsoft, Unix, ChromeOS or Android by Google, etc.

The data storage 262 may include data such as application data for the plurality of applications 264, routine data for the plurality of routines 268, and/or other data necessary to interact the one or more servers 105, the network 110, the coordinator UCDs 35A, etc. In some embodiments, the controller 242 may also include, or otherwise be communicatively connected to, other data storage mechanisms (e.g., one or more hard disk drives, optical storage drives, solid state storage devices, etc.) that reside within the NCD 245.

The communication component 258 may communicate with the one or more

components or devices, such as the server 105 and/or the coordinator UCD 35A, via any suitable wireless communication protocol network, such as a wireless telephony network (e.g., GSM, CDMA, LTE, 5G, 6G, ultrawideband, etc.), a LoRaWAN network, a Wi-Fi network (e.g., having 802.11 standards), a WiMAX network, a Bluetooth network, etc. As described herein, unlike the communication link between the NCD 245 and the server 105, the communication link between the NCD 245 and the UCD 35A may be a direct, point-to-point communication link due to the lack of traditional network connectivity at the location of the UCD 35A. The user-input device (not shown) may include a “soft” keyboard that is displayed on the display 240 of the NCD 245, an external hardware keyboard communicating via a wired and/or a wireless connection (e.g., a Bluetooth keyboard), an external mouse, a touchscreen, a stylus, and/or any other suitable user-input device.

The one or more processors 248 may be adapted and/or configured to execute any of the plurality of software applications 264 and/or any of the plurality of software routines 268 residing in the program memory 246, in addition to other software applications.

One of the plurality of applications 264 may be a native application and/or web browser 270, such as Apple's Safari, Google's Chrome, Microsoft's Edge, Mozilla's Firefox, that may be implemented as a series of computer-executable instructions for receiving, interpreting, and/or displaying application screens or web page information from the one or more servers 105 while also receiving inputs from the user. Another application of the plurality of applications may include an embedded web browser 276 that may be implemented as a series of machine-readable instructions for receiving, interpreting, and/or displaying web page information.

One of the plurality of applications 264 may be an application for performing the various tasks and/or functions associated with operating a network of unit collection devices, such as displaying a user interface (UI) associated with aggregate sensor datasets (e.g., receiving, decrypting, tens mitting, etc.), the management platform (e.g., receiving analytics, optimized routes, notifications, etc.), displaying information on, and/or transmitting information from, the NCD 245 to the server 105, etc. One of the plurality of software routines 268 may be a routine to receive the aggregate sensor dataset when within communication range of the coordinator UCD 35A. Additionally, the user may also launch or instantiate any other suitable application (e.g., the native application or web browser 270, and/or any other software application 264) and/or routine 268 to access the one or more servers 105 and/or the coordinator UCDs 35A to realize aspects of the inventive system.

The NCD 245 may include additional, fewer, and/or alternate components, and may be configured to perform additional, fewer, or alternate actions, including components/actions described herein. Although the NCD 245 is shown in FIG. 2 as including one instance of various components such as the display 240, the processor 248, etc., various aspects include the NCD 245 implementing any suitable number of any of the components shown in FIG. 2 and/or omitting any suitable ones of the components shown in FIG. 2. Moreover, various aspects include the NCD 245 including any suitable additional component(s) not shown in FIG. 2, such as but not limited to the exemplary components described with respect to other figures, such as FIG. 1. Furthermore, it should be appreciated that additional and/or alternative connections between components shown in FIG. 2 may be implemented.

### Exemplary ML Model Training

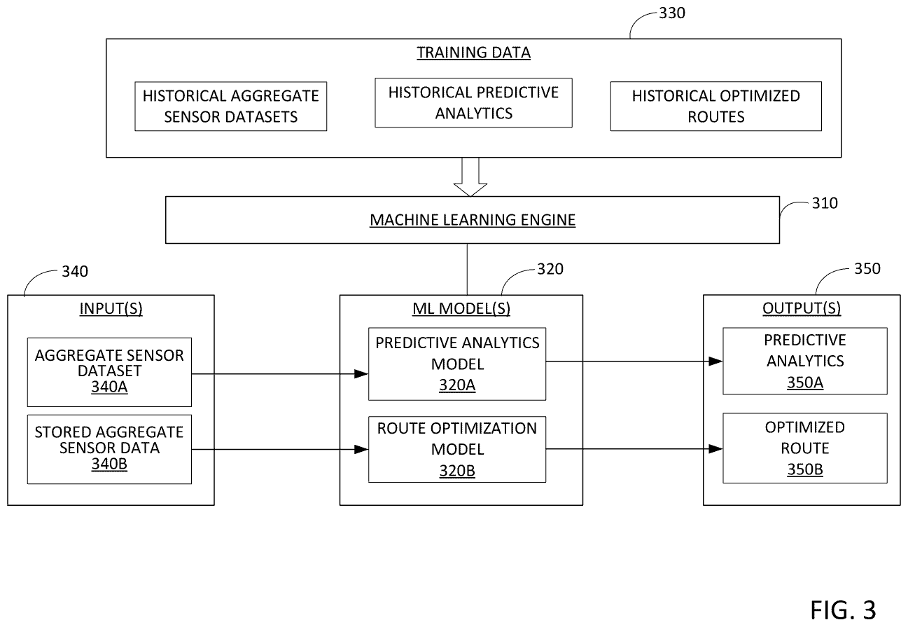

FIG. 3 schematically illustrates training an ML, more specifically, using an ML engine 310 to train an ML model 320 using training data 330 to receive an input 340 and generate an output 350. The ML model training may be implemented on a server, such as server 105, and/or other suitable devices and/or components, such as those described with respect to the computing environment 100 of FIG. 1.

The ML engine 310 may include one or more hardware and/or software components (e.g., the ML module 138, the MLTM 140 and/or the MLOM 142) to obtain, create, (re)train, operate, fine-tune, and/or store the ML model 320. To train the ML model 320, the ML engine 310 may use training data 330. A server, such as server 105, may obtain and/or have available one or more types of training data 330 (e.g., training data stored in database 126). In at least one aspect, at least some of the training data 330 may be labeled to aid in (re)training and/or fine-tuning the ML model 320. The ML model 320 may be configured to process the training data 330 to learn associations and relationships in the training data 330. The ML engine 310 may process and/or analyze the training data 330 (e.g., via MLTM 140) to train the ML model 320 to generate the output 350 based upon receiving the input 340. The ML model 320 may be trained via regression, k-nearest neighbor, support vector regression, and/or random forest algorithms and/or models, although any type of applicable ML algorithm and/or model may be used, including training using one or more of supervised learning, unsupervised learning, semi-supervised learning, and/or reinforcement learning.

In one aspect, the ML models 320 may include a predictive analytics ML model 320A trained to receive aggregate sensor dataset 340A (and/or a collection of stored aggregate sensor data 340B) as an input 340 and generate predictive analytics 350A as an output 350. The training data for the 330 predictive analytics ML model 320A may include historical aggregate sensor datasets of historical portable structures, historical predictive analytics data of historical portable structures, and/or any other suitable training data 330. The predictive analytics ML model 320A may be trained to learn associations and/or relationships in the training data 330. In one example, the historical aggregate sensor datasets may indicate historical conditions (e.g., cleanliness, level of consumables, etc.) of historical portable structures, and the change in historical conditions over time. The historical predictive analytics data may indicate historical predictions made for historical portable structures. Such training data 330 may indicate predictions that could have been made, whether predictions that were made were valid and/or accurate, etc. Thus, during training, the predictive analytics ML model 320A may be trained to learn associations and/or relationships between the features of the historical aggregate sensor datasets and historical predictive analytics data. For example, the predictive analytics ML model 320A may learn that the portable structure location, the time of the year, and the waste reservoir level are the three most important features of historical aggregate sensor datasets when predicting the odor level of a portable structure, among other things.

In one aspect, the ML models 320 may include a route optimization ML model 320B trained to receive aggregate sensor dataset 340A as an input 340 and generate an optimized route 350B to collect aggregate sensor data from a coordinator UCD, such as coordinator UCD 35A. The training data 330 for the route optimization ML model 320B may include historical aggregate sensor datasets of historical portable structures, historical optimized route data indicating historical optimized routes which were traveled to collect historical aggregate sensor datasets, and/or other suitable training data 330. The route optimization ML model 320B may be trained to learn associations and/or relationships in the training data 330. In one example, the historical aggregate sensor datasets may indicate historical locations of historical coordinator UCDs, and when historical aggregate sensor datasets were collected from the historical coordinator UCDs. The historical optimized route data may indicate historical optimized routes generated to collect the historical aggregate sensor datasets. The training data 330 may indicate whether the optimized routes were optimal, or whether better route may have been taken to collect the historical aggregate sensor datasets more quickly. Thus, during training, the route optimization ML model 320B may be trained to learn associations and/or relationships between the features of the historical aggregate sensor datasets and historical predictive analytics data. For example, the route optimization ML model 320B may learn that the time of day may be the most important feature of historical aggregate sensor datasets when determining whether one route is more optimal than another for collecting aggregate sensor datasets, among other things.

In at least one aspect, the ML models 320 may be considered as successfully trained once the ML model 320 is able to achieve one or more validation metrics (e.g., recall score, specificity score, etc.) associated with its performance when processing the training data 330 to generate the output 350.

Once trained, the ML model 320 may perform operations on data input(s) 340 (e.g., data similar to the training data 330) to produce the desired data output(s) 350. In one aspect, the ML models 320 may be loaded at runtime from storage (e.g., by ML engine 310 from the memory 124) to process the input data 340. The server and/or ML engine 310 may obtain the input data 340 (e.g., from the database 126), and provide the input data 340 to the trained ML models 320 to generate the output 350.

The predictive analytics ML model 320A may receive an aggregate sensor dataset 340A as the input 340 to generate the predictive analytics 350A as the output 350. For example, a server may retrieve the aggregate sensor dataset 340A from a storage platform (e.g., database 126) via a network (e.g., network 110). The server may load the aggregate sensor dataset 340A from memory (e.g., memory 124) using the ML engine 310, and provide the aggregate sensor dataset 340A to the predictive analytics ML model 320A. The predictive analytics ML model 320A may generate one or more predictive analytics 350A for one or more of the portable structures associated with the aggregate sensor dataset 340A. In one example, the predictive analytics 350A may indicate when the waste reservoir of the portable structure may need to be emptied, when toilet paper is expected to run out, when the next cleaning should be, how much toilet paper, paper towels and soap should be ordered, etc.

Similarly, the route optimization ML model 320B may receive the aggregate sensor dataset 340A as the input 340 to generate the optimized route 350B as the output 350. For example, the server may retrieve the aggregate sensor dataset 340A from a storage platform (e.g., database 126) via a network (e.g., network 110). The server may load the aggregate sensor dataset 340A from memory (e.g., database 126) using the ML engine 310, and provide the aggregate sensor dataset 340A to the route optimization ML model 320B. The route optimization ML model 320B may generate an optimized route 350B to travel to collect subsequent aggregate sensor datasets from coordinator UCDs. In one example, the optimized route 350B may indicate directions to each coordinator UCD, travel time, route maps, etc.

The server and/or ML engine 310 may update the training data 330 at one or more times. For example, when the trained predictive analytics ML model 320A generates the predictive analytics 350A, the server and/or ML engine 310 may store as updated training data the associated input data 340 (e.g., aggregate sensor dataset 340A), the associated output data 350A (e.g., the predictive analytics), data associated with the predictive analytics 350A (e.g., the accuracy of the predictions once the predictions have come to pass), and/or any other suitable data to store as updated training data. The ML model(s) 320 may be retrained based upon the updated training data 330, stored in memory, and/or executed to generate subsequent, improved output 350 based upon the retraining. This process may cause the output 350 of the ML model(s) 320 to improve over time. Continuing with the previous example, the data associated with the predictive analytics 350A may be stored as updated training data. The predictive analytics ML model 320A may be retrained with such data, which may indicate whether the predictive analytics 350A were at least in-part valid. Once retrained, the accuracy of the predictive analytics 350A the predictive analytics ML model 320A generates may be improved.

### Exemplary System for Providing Operational Support for UCDs

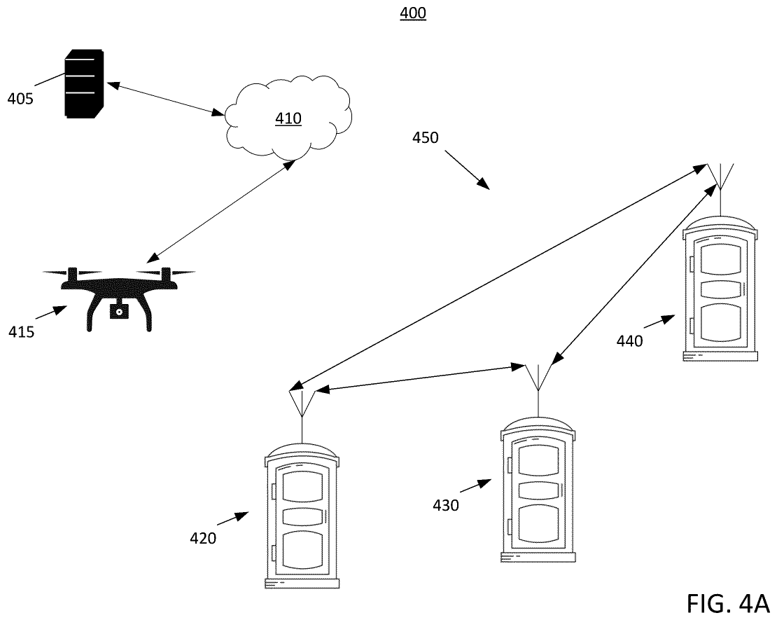

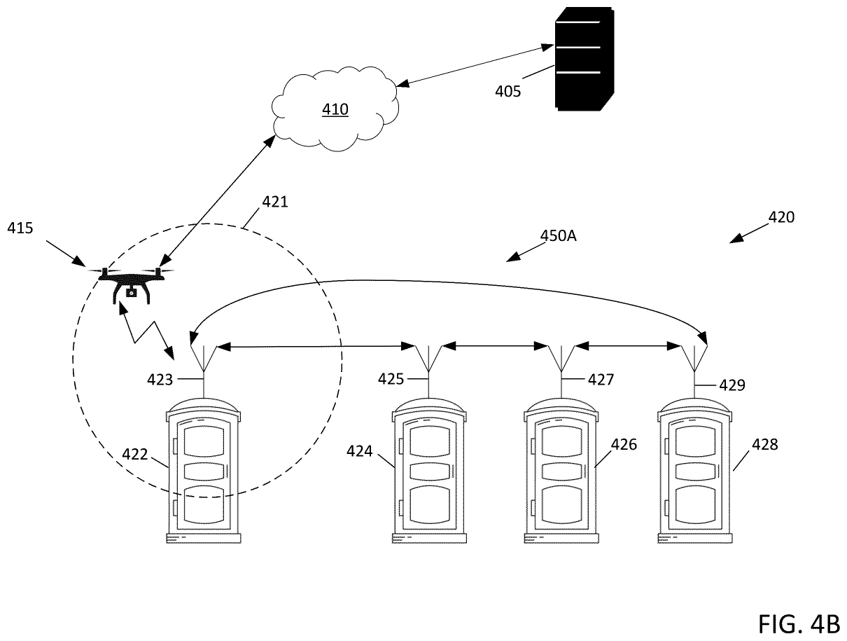

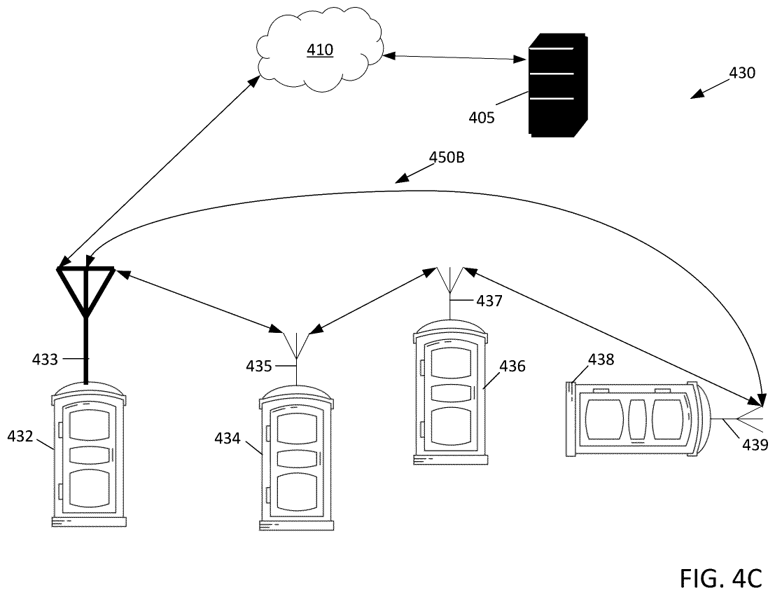

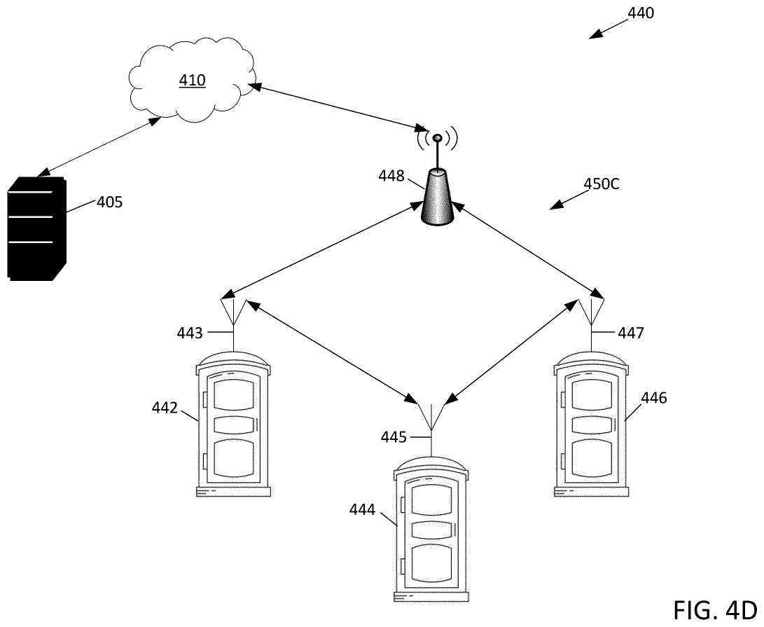

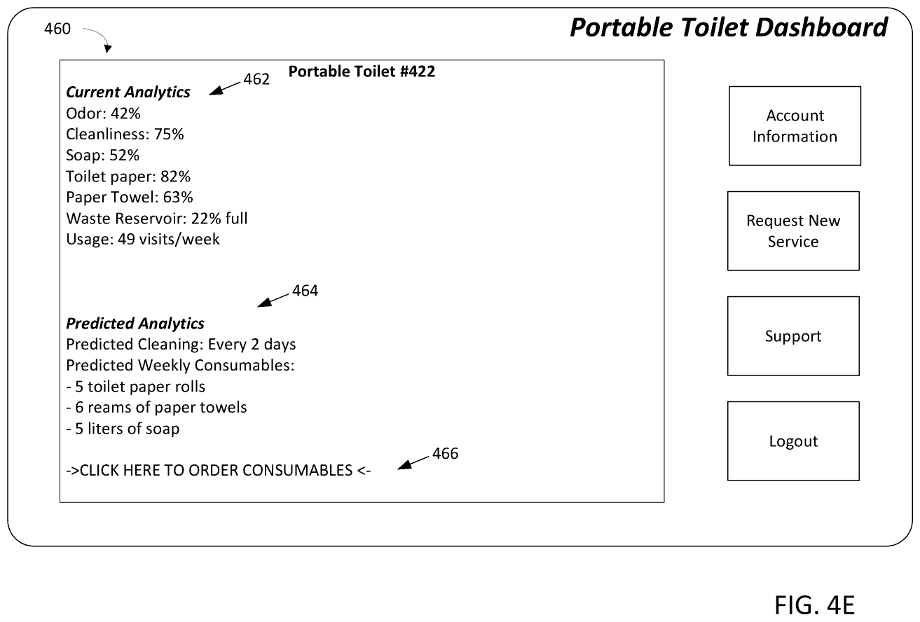

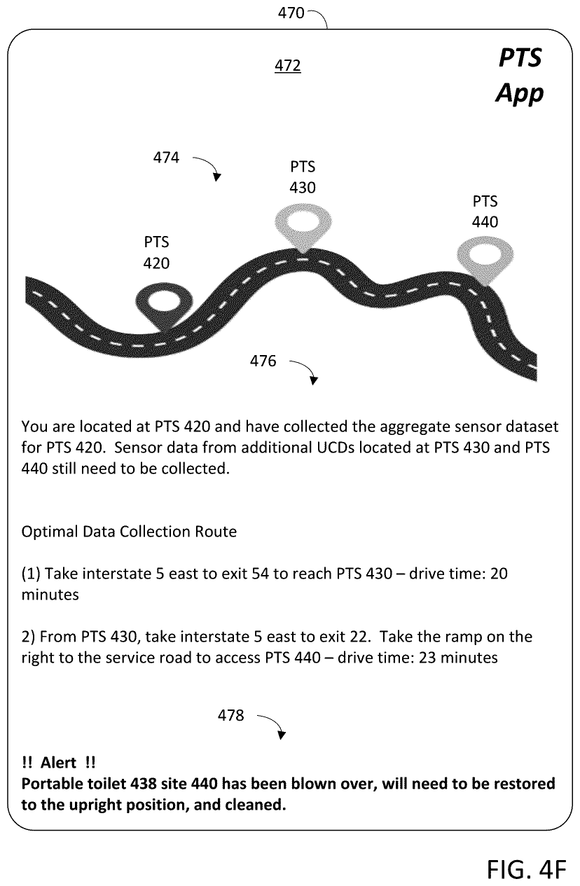

FIG. 4A is a block diagram of an exemplary system 400 for operating a network of unit UCDs, such as UCDs 35. A server 405 including a storage platform may be communicatively coupled to an NCD drone (drone) 415 via the network 410, such as server 105, NCD 45, and network 110 respectively. The system 400 may include three portable toilet sites 420, 430, 440 operated by the same entity. The UCDs of each portable toilet site 420, 430, 440 are configured to form a mesh network 450 such as the mesh network 50. The drone 415 may be configured to retrieve aggregate sensor datasets from each of the portable toilet sites 420, 430, 440.

FIG. 4B is a block diagram of the first portable toilet site 420. The portable toilet site 420 includes four portable toilets 422, 424, 426, 428 having corresponding UCDs 423, 425, 427, 429 respectively. The UCD 423 may be designated as the coordinator UCD for the portable toilet site 420, although in other embodiments any of the other UCDs 425, 427, 429 may be designated as the coordinator UCD. The UCDs 423, 425, 427, 429 may be configured to form a subnetwork 450A of the larger mesh network 450. The UCDs 423, 425, 427, 429 may each receive sensor data from sensors (e.g., sensors 15) associated with their respective portable toilets 422, 424, 426, 428. The UCDs 425, 427, 429 may provide their sensor data to the coordinator UCD 423 via the subnetwork 450A. The coordinator UCD 423 may generate an aggregate sensor dataset from the sensor data associated with the portable toilets 422, 424, 426, 428 of the portable toilet site 420, and store the aggregate sensor dataset locally on a memory. Once within wireless communication range 421 of the coordinator UCD 423, the drone 415 may receive the aggregate sensor dataset from the coordinator UCD 423 for the portable toilet site 420 via a Bluetooth (or other direct) data transmission channel. The drone 415 may store the aggregate sensor dataset for the portable toilet site 420 locally in memory, may transmit the aggregate sensor dataset for the portable toilet site 420 to the storage platform of the server 405 via the network 410, and/or provide the aggregate sensor dataset to any other suitable storage platform.

In some embodiments, the drone 415 may then travel to the portable toilet site 430 and the portable toilet site 440 to repeat the process, i.e., collect the aggregate sensor dataset for the portable toilet site 430 from one or more UCDs designated as the coordinator UCD at the portable toilet site 430, and collect the aggregate sensor dataset for the portable toilet site 440 from one or more UCDs designated as the coordinator UCD at the portable toilet site 440. The drone may provide the aggregate sensor datasets of the portable toilet sites 420, 430, 440 to the storage platform of the server 405.

In some embodiments, one or more of the UCDs, such as the coordinator UCD, may be configured to provide the aggregate sensor data directly to the storage platform. FIG. 4C is a block diagram of the second portable toilet site 430. The portable toilet site 430 includes four portable toilets 432, 434, 436, 438 having corresponding UCDs 433, 435, 437, 439 respectively, and forming mesh subnetwork 450B. The portable toilet site 430 is located at a site that regularly experiences strong winds, during which times the drone 415 is unable to safely travel to the portable toilet site 430 to collect the associated aggregate sensor dataset. The coordinator UCD 433 receives data from an environmental sensor (e.g., sensor 15) at the portable toilet site 430 which detects when the wind speed is too high for the drone 415 to operate. During such times of high wind, the coordinator UCD 433 activates its long-range communication connections so that it may provide the aggregate sensor dataset of the portable toilet site 430 to the storage platform of the server 405 via the network 410. The long-range communication connections are otherwise deactivated, to save power of the coordinator UCD 433. During a particularly windy day, the portable toilet 438 is blown over on its side. A sensor of the portable toilet 438 detects the movement of the portable toilet 438 while being blown over, and provides the associated sensor data to the corresponding UCD 439. The UCD provides the sensor data to the coordinator UCD 433 via the mesh subnetwork 450B using LoRaWAN communication. The coordinator UCD 433, which already has its long-range NB-IoT communication connection activated due to the high winds, is able to send the aggregate sensor dataset, including the sensor data indicating the portable toilet 438 is tipped over, to the storage platform of the server 405 via the network 410 using the long-range NB-IoT communication connection. The server 405, e.g., via a management platform which analyzes the aggregate sensor dataset, may schedule a service call for the portable toilet site 430, so the portable toilet 438 may be returned to its upright position.

In some embodiments, the coordinator UCD may not be a UCD, but rather a device such as a base station which provides the aggregate sensor dataset(s) of a mesh (sub)network to the storage platform. FIG. 4D is a block diagram of the third portable toilet site 440. The portable toilet site 440 includes three portable toilets 442, 444, 446 having corresponding UCDs 443, 445, 447 respectively, which form the mesh subnetwork 450C. The portable toilet site 440 is a temporary site which will only be in operation a few days, and also experiences the effects of high winds, similarly preventing the drone 415 from collecting the aggregate sensor dataset of the mesh subnetwork 450C. Rather than installing additional costly long-term communication hardware on the UCDs 443, 445, 447 which will only be in use a few days, a base station 448 configured as the coordinator UCD is deposited at the portable toilet site 440. The base station 448 receives sensor data from each of the UCDs 443, 445, 447 and generates an aggregate sensor dataset for the portable toilet site 440. The base station 448 stores the aggregate sensor dataset in a local memory, and also transmits the aggregate sensor dataset via a low-earth orbit satellite connection to the storage platform of the server 405.

The server 405 may provide aggregate sensor datasets, such as the aggregate sensor datasets for the portable toilet sites 420, 430, 440, to a management platform (e.g., management platform 134) executed by the server 405. The management platform may receive and analyze the aggregate sensor datasets, for example to generate analytics for the portable toilet sites 420, 430, 440. This may include analytics for each of the portable toilets at the portable toilet sites 420, 430, 440, analytics for the portable toilet sites as a whole, some combination thereof, and/or any other suitable analytics. The management platform may provide the analytics via a website, software application, mobile application, and the like, associated with the management platform, and/or in any other suitable manner (e.g., an electronic analytics report sent to a customer via email, etc.).

In one example, the analytics may be associated with water (e.g., water tank level, water flow, water evaporation rate, water freshness, and/or water temperature). In one example, the analytics may be associated with the portable toilet interior, such as odor, chemical effectiveness, and/or occupancy detection. The management platform may generate any other suitable analytics.

The management platform may generate other information, which may not be based upon the aggregate sensor datasets. For example, the information may include customer satisfaction information, operation costs, customer account information, and/or any other suitable information.

In one aspect, the management platform may generate one or more electronic alerts for the portable toilet sites 420, 430, 440. For example, when determining the portable toilet 438 has been knocked on its side from analyzing the associate aggregate sensor dataset for portable toilet site 430, the management platform may generate an associated alert, and transmit the alert via the network 410 to one or more user devices, such as the NCD 45, of service technicians near the portable toilet site 430, so the portable toilet 438 may be repositioned. The management platform may generate other suitable information based upon the aggregate sensor datasets.

The management platform may execute one or more ML models. In one aspect, the management platform may execute a predictive analytics ML model, such as the predictive analytics ML models 130, 320A. The management platform may provide the aggregate sensor dataset to the predictive analytics ML model to generate predictive analytics, such as predicting usage of the portable structure, cleanliness, level of consumables, and servicing of the portable structure, etc. FIG. 4E depicts an exemplary management platform analytics dashboard 460. The dashboard may be accessed, for example, via the server 405 executing the management platform using a web browser (e.g., browser 270) of a computing device, such as a desktop computer. The analytics dashboard 460 may provide current analytics 462 and predictive analytics 464 for the portable toilet 422 of FIG. 4B. The management platform may provide one or more support services based at least in part on the analytics. In one aspect, the analytics 462 and the predictive analytics 464 of the analytics dashboard 460 may be the support services. In one aspect, the management platform may provide consumable ordering for the portable structure, such as allowing a customer to order consumables for the portable toilets via the link 466 of the analytics dashboard 460. In one aspect, the management platform may provide operational support services, such as scheduling visiting to the portable structure by a service technician, e.g., for cleaning, repair, installation, and/or removal of the portable structure, among other things.

In one example, the aggregate sensor dataset from the portable toilet sites 420, 430, 440 may be collected by a service technician associated with the management platform. The service technician may drive to each portable toilet site with a smartphone which is configured as the NCD. The smartphone NCD may obtain (e.g., from the management platform via network 410) an expected set of UCD identifiers associated with sensor data expected to be included in the aggregate sensor datasets collected from the portable toilet sites 420, 430, 440 of the mesh network 450. After each set of aggregate sensor datasets is collected from each portable toilet site 420, 430, 440, the smartphone NCD may compare the expected set of UCD identifiers to a received set of UCD identifiers included in the received aggregate sensor dataset of each portable toilet site to identify expected UCD identifiers not included within the UCD identifiers.

FIG. 4F depicts an exemplary user interface 472 of the smartphone NCD 470, such as the NCD 45, 245. According to the user interface 472, the service technician is at the portable toilet site 420 to collect the associated aggregate sensor dataset, as previously described with respect to NCD drone 415 collecting the aggregate sensor dataset from the portable toilet site 420. The user interface 472 indicates that the service technician must also visit the portable toilet site 430 and the portable toilet site 440 to collect aggregate sensor dataset of additional UCDs, as the expected UCD identifiers include UCD identifiers of UCDs at the portable toilet sites 430 and 440 when comparing the expected UCD identifiers to those of the aggregate sensor dataset of the portable toilet site 420.

In one aspect, the management platform may provide an optimal route to collect the aggregate sensor dataset as a support service, e.g., via the route optimization ML model such as route optimization ML models 132, 320B. The management platform may execute the route optimization ML model when providing the aggregate sensor dataset to the route optimization ML model to generate the optimized route. The user interface 472 indicates the optimal route to portable toilet site 430 and the portable toilet site 440 generated by the route optimization ML model. The optimal route includes a map 474 along with direction 476.

In one aspect, the management platform may provide may generate and provide one or more electronic alert to one or more devices, such as transmitting an alert 478 to the smartphone NCD 470 via the network 410 for display on the user interface 472. As illustrated in FIG. 4F, the user interface 472 includes the alert 478 to the service technician indicating the toppled portable toilet 438 at site 440.

### Exemplary Computer-Implemented Methods for Operating a Network of UCDs

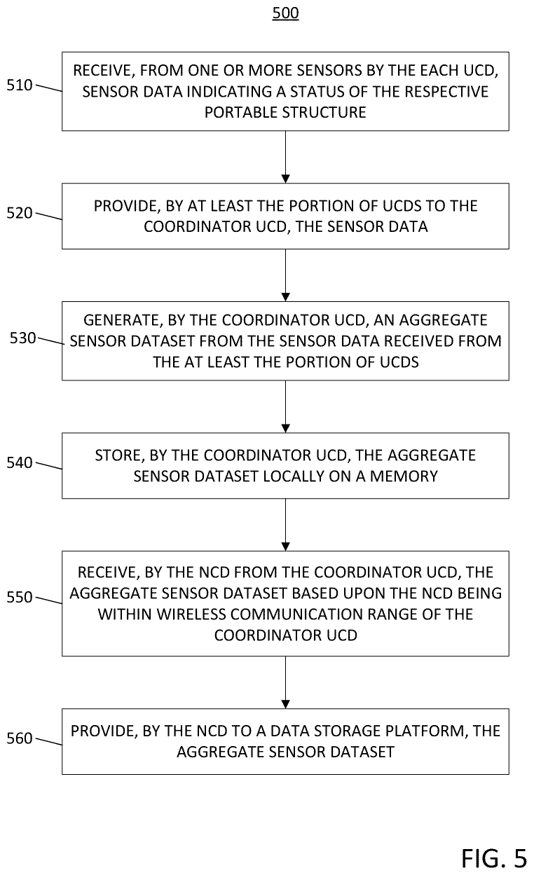

FIG. 5 is an exemplary block flow diagram depicting a method 500 for operating a network of UCDs. In general, the method 500 may be implemented by the devices, models, and/or other components of the computing environment 100 and/or system 400. One or more steps of the computer-implemented method 500 may be implemented as a set of instructions stored on a computer-readable memory (e.g., the memory 124) and executable by one or more processors (e.g., the processor 120).

In one embodiment, the method 500 may include a plurality of UCDs (e.g., the UCD 35), wherein each UCD of the plurality of UCDs is associated with a respective portable structure (e.g., the portable structure 25). The plurality of UCDs may be configured to operate as a node in a long-range wireless mesh network (e.g., the wireless mesh network 50), which may include a bidirectional mesh network based upon a LoRaWAN protocol. One or more of the UCDs may be configured to operate as a coordinator UCD (e.g., a coordinator UCD 35A) for at least a portion of UCDs of the plurality of UCDs.

In one embodiment, the method 500 may include an NCD (e.g., the NCD 45, 245) configured to collect the aggregate sensor dataset from the coordinator UCD, and provide the aggregate sensor dataset to a storage platform (e.g., the database 126 of server 105). The NCD may be configured to receive the aggregate sensor dataset via a Bluetooth communication connection with the coordinator UCD. In at least one aspect of the method 500, the NCD may be further configured to receive an additional aggregate sensor dataset from an additional coordinator UCD associated with an additional long-range wireless mesh network.

According to an embodiment, the method 500 may include receiving, from one or more sensors by the each UCD, sensor data indicating a status of the respective portable structure (block 510). The sensor data may indicate a location, a frequency of use, a hygiene level, a door lock status, and/or a level of a consumable product.

The method 500 may include providing, by at least the portion of UCDs to the coordinator UCD, the sensor data (block 520).

The method 500 may include generating, by the coordinator UCD, an aggregate sensor dataset from the sensor data received from the at least the portion of UCDs (block 530). The received sensor data may include UCD identifiers associated with the UCDs from which the sensor data is received.

The method 500 may include storing, by the coordinator UCD, the aggregate sensor dataset locally on a memory (block 540).

The method 500 may include receiving, by the NCD from the coordinator UCD, the aggregate sensor dataset based upon the NCD being within wireless communication range of the coordinator UCD (block 550).

The method 500 may include providing, by the NCD to a data storage platform, the aggregate sensor dataset (block 560).

In at least one aspect, the method 500 may further include (i) obtaining, by the NCD for aggregate sensor dataset, expected UCD identifiers of the UCDs expected to provide the sensor data comprising the aggregate sensor dataset; (ii) comparing, by the NCD, the expected UCD identifiers to the UCD identifiers of the aggregate sensor dataset to identify expected UCD identifiers not included within the UCD identifiers; and (a) wherein the expected UCD identifiers match the received UCD identifiers, providing, by the NCD, a notification indicating the aggregate sensor dataset is successfully received; or (b) wherein the expected UCD identifiers do not match the received UCD identifiers, identify, by the NCD, an additional coordinator NCD at which the sensor data associated with an unmatched expected UCD identifier is stored.

In at least one aspect of the method 500, at least a first portion of the plurality of UCDs comprise a first subnetwork, at least a second portion of the plurality of UCDs comprise a second subnetwork, and a UCD may be included in the first and second subnetworks. In such an aspect, the method 500 may further include communicating between the UCDs of the first subnetwork and UCDS of the second subnetwork.

In at least one aspect of the method 500, the aggregate sensor dataset may be encrypted and may include a customer identifier. In such an aspect, the method 500 may include identifying, by the NCD, a decryption key associated with the customer identifier, and decrypting, by the NCD, the aggregate sensor dataset using the decryption key.

In at least one aspect, the method 500 is further implemented by a management platform for providing operational support for the plurality of UCDs and the portable structures. The management platform may be stored as processor-executable instructions on one or more memories and executed by one or more processors. In such an aspect, the method 500 may include (i) receiving, by the management platform from the data storage platform, the aggregate sensor dataset; (ii) analyzing, by the management platform, the aggregate sensor dataset to generate analytics for the portable structures associated with plurality of UCDs; and (iii) providing, by the management platform, one or more support services based at least in part on the analytics.

In at least one aspect of the method 500, the management platform may store model data associated with a machine learning model. The machine learning model may be trained using training data. The machine learning model may be selected from the group consisting of a predictive analytics model and route optimization model. In such an aspect, the method may include executing, by the management platform, the machine learning model.

It should be understood that not all blocks of the exemplary flow diagram of FIG. 5 are required to be performed.

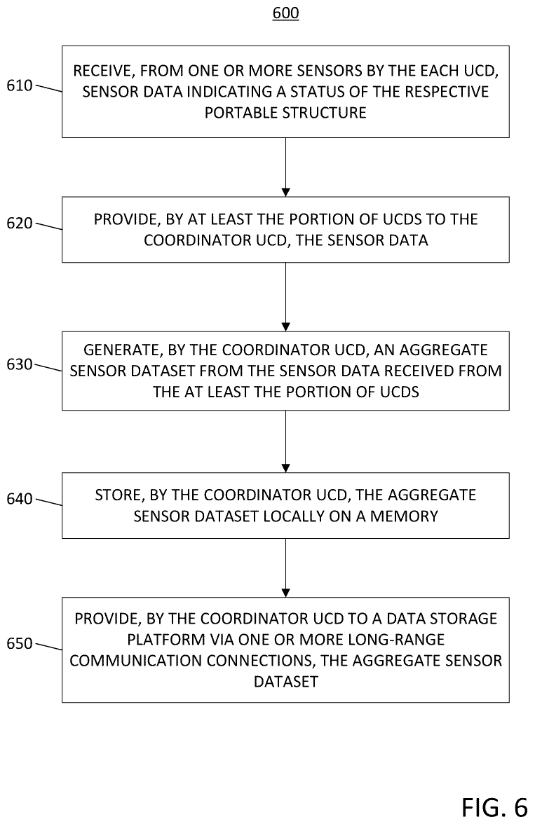

FIG. 6 is an exemplary block flow diagram depicting a method 600 for operating a network of UCDs. In general, the method 600 may be implemented by the devices, models, and/or other components of the computing environment 100 and/or system 400. One or more steps of the computer-implemented method 600 may be implemented as a set of instructions stored on a computer-readable memory (e.g., the memory 124) and executable by one or more processors (e.g., the processor 120).

In one embodiment, the method 600 may include a plurality of UCDs (e.g., the UCDs 35), wherein each UCD of the plurality of UCDs is associated with a respective portable structure (e.g., the portable structure 25). The plurality of UCDs may be configured to operate as a node in a long-range wireless mesh network (e.g., the wireless mesh network 50), which may include a bidirectional mesh network based upon a LoRaWAN protocol.

In one embodiment, the method 600 may include a coordinator UCD (e.g., the coordinator UCDs 35A) for at least a portion of UCDs of the plurality of UCDs. The coordinator UCD may be configured to receive the sensor data, generate an aggregate sensor dataset from the sensor data, and provide the aggregate sensor dataset to a storage platform. The coordinator UCD may be at least one of the plurality of UCDs. The coordinator UCD may be a base station.

According to an embodiment, the method 600 may include receiving, from one or more sensors by the each UCD, sensor data indicating a status of the respective portable structure (block 610). The sensor data may indicate a location, a frequency of use, a hygiene level, a door lock status, and/or a level of a consumable product.

The method 600 may include providing, by at least the portion of UCDs to the coordinator UCD, the sensor data (block 620).

The method 600 may include generating, by the coordinator UCD, an aggregate sensor dataset from the sensor data received from the at least the portion of UCDs (block 630). The received sensor data may include UCD identifiers associated with the UCDs from which the sensor data is received.

The method 600 may include storing, by the coordinator UCD, the aggregate sensor dataset locally on a memory (block 640).

The method 600 may include providing, by the coordinator UCD to a data storage platform via one or more long-range communication connections, the aggregate sensor dataset (block 650). The one or more long-range communication connections may be selected from the group consisting of: long term evolution machine type communication, narrowband-internet of things, and satellite. At least one of the one or more long-range communication connections may be subscription-based. At least one long-range communication connection, of the one or more long-range communication connections, may be activated based upon the aggregate sensor dataset, such as the aggregate sensor dataset indicating movement of the portable structure associated with the aggregate sensor dataset.

In at least one aspect, the method 600 may be further implemented by a management platform for providing operational support for the plurality of UCDs and associated portable structures, the management platform stored as processor-executable instructions on one or more memories and executed by one or more processors. In such an aspect, the method 600 may further include receiving, by the management platform from the data storage platform, the aggregate sensor dataset; analyzing, by the management platform, the aggregate sensor dataset to generate analytics for the portable structures; and providing, via the management platform, one or more support services based at least in part on the analytics. In such an aspect, the method 600 may further include generating, by the management platform, one or more electronic alerts based upon the aggregate sensor dataset; and providing the one or more electronic alerts via the management platform and/or to a user device by the management platform.

It should be understood that not all blocks of the exemplary flow diagram of FIG. 6 are required to be performed.

### Aspects

The following list of aspects reflects a variety of the embodiments explicitly contemplated by the present disclosure. Those of ordinary skill in the art will readily appreciate that the aspects below are neither limiting of the embodiments disclosed herein, nor exhaustive of all of the embodiments conceivable from the disclosure above, but are instead meant to be exemplary in nature.

Aspect 1. A system for operating a network of unit collection devices (UCDs), the system comprising: a plurality of UCDs, wherein each UCD of the plurality of UCDs is associated with a respective portable structure and configured to: receive sensor data from one or more sensors, the sensor data indicating a status of the respective portable structure; operate as a node in a long-range wireless mesh network comprising the plurality of UCDs; provide the sensor data to a coordinator UCD of the long-range wireless mesh network; and operate as the coordinator UCD for at least a portion of UCDs of the plurality of UCDs to: generate an aggregate sensor dataset from the sensor data received from at least the portion of UCDs, wherein the received sensor data includes UCD identifiers associated with the UCDs from which the sensor data is received, and store the aggregate sensor dataset locally on a memory; and a network collection device (NCD) for collecting the aggregate sensor dataset from the coordinator UCD, and providing the aggregate sensor dataset to a storage platform, the NCD configured to: receive, from the coordinator UCD, the aggregate sensor dataset in response to the NCD being within wireless communication range of the coordinator UCD; and provide the aggregate sensor dataset to a data storage platform.

Aspect 2. The system of aspect 1, wherein the sensor data indicates one or more of a location, a frequency of use, a hygiene level, a door lock status, or a level of a consumable product.

Aspect 3. The system of aspects 1 to 2, wherein the long-range wireless mesh network is a bidirectional mesh network based upon a LoRaWAN protocol.

Aspect 4. The system of any one of aspects 1 to 3, wherein the NCD is further configured to: obtain, for the long-range wireless mesh network, an expected set of UCD identifiers associated with sensor data expected to be included in the aggregate sensor dataset; compare the expected set of UCD identifiers to a received set of UCD identifiers included in the received aggregate sensor dataset to identify expected UCD identifiers not included within the UCD identifiers; and wherein the expected UCD identifiers match the received UCD identifiers, provide a notification indicating the aggregate sensor dataset is successfully received; or wherein the expected UCD identifiers do not match the received UCD identifiers, identify an additional coordinator NCD at which the sensor data associated with an unmatched expected UCD identifier is stored.

Aspect 5. The system of any one of aspects 1 to 4, wherein the NCD is configured to receive the aggregate sensor dataset via a Bluetooth communication connection with the coordinator UCD.

Aspect 6. The system of any one of aspects 1 to 5, wherein: at least a first portion of the plurality of UCDs comprise a first subnetwork; at least a second portion of the plurality of UCDs comprise a second subnetwork; and UCDs of the first subnetwork and the second subnetwork are further configured to communicate with each other.

Aspect 7. The system of aspect 6, wherein a UCD is included in the first subnetwork and the second subnetwork.

Aspect 8. The system of any one of aspects 1 to 7, wherein the NCD is further configured to receive an additional aggregate sensor dataset from an additional coordinator UCD associated with an additional long-range wireless mesh network.

Aspect 9. The system of any one of aspects 1 to 8, wherein the aggregate sensor dataset is encrypted and includes a customer identifier, and the NCD is further configured to: identify a decryption key associated with the customer identifier; and decrypt the aggregate sensor dataset using the decryption key.

Aspect 10. The system of any one of aspects 1 to 9, further comprising: a management platform for providing operational support for the plurality of UCDs and associated portable structures, the management platform stored as processor-executable instructions on one or more memories that, when executed by one or more processors, cause the management platform to: receive the aggregate sensor dataset from the data storage platform; analyze the aggregate sensor dataset to generate analytics for the portable structures; and provide, via the management platform, one or more support services based at least in part on the analytics.

Aspect 11. The system of aspect 10, wherein: the management platform stores model data associated with a machine learning model trained using training data; and the management platform further comprises instructions that, when executed by the one or more processors, cause the management platform to execute the machine learning model.

Aspect 12. The system of aspect 11, wherein the machine learning model is selected from the group consisting of a predictive analytics model and route optimization model.

Aspect 13. A method for operating a network of unit collection devices (UCDs) implemented by a plurality of UCDs, wherein each UCD of the plurality of UCDs is associated with a respective portable structure and configured to operate as a node in a long-range wireless mesh network comprising the plurality of UCDs, and operate as a coordinator UCD for at least a portion of UCDs of the plurality of UCDs, and a network collection device (NCD) configured to collect an aggregate sensor dataset from the coordinator UCD, and provide the aggregate sensor dataset to a storage platform, the method comprising: receiving, from one or more sensors by the each UCD, sensor data indicating a status of the respective portable structure; providing, by the at least the portion of UCDs to the coordinator UCD, the sensor data; generating, by the coordinator UCD, an aggregate sensor dataset from the sensor data received from at least the portion of UCDs, wherein the received sensor data includes UCD identifiers associated with the UCDs from which the sensor data is received; storing, by the coordinator UCD, the aggregate sensor dataset locally on a memory; receiving, by the NCD from the coordinator UCD, the aggregate sensor dataset based upon the NCD being within wireless communication range of the coordinator UCD; and providing, by the NCD to a data storage platform, the aggregate sensor dataset.

Aspect 14. The method of aspect 13, wherein the long-range wireless mesh network is a bidirectional mesh network based upon a LoRaWAN protocol.

Aspect 15. The method of aspects 13 or 14, further comprising: obtaining, by the NCD for aggregate sensor dataset, expected UCD identifiers of the UCDs expected to provide the sensor data comprising the aggregate sensor dataset; comparing, by the NCD, the expected UCD identifiers to the UCD identifiers of the aggregate sensor dataset to identify expected UCD identifiers not included within the UCD identifiers; and wherein the expected UCD identifiers match the received UCD identifiers, providing, by the NCD, a notification indicating the aggregate sensor dataset is successfully received; or wherein the expected UCD identifiers do not match the received UCD identifiers, identify, by the NCD, an additional coordinator NCD at which the sensor data associated with an unmatched expected UCD identifier is stored.

Aspect 16. The method of any one of aspects 13 to 15, wherein: at least a first portion of the plurality of UCDs comprise a first subnetwork; at least a second portion of the plurality of UCDs comprise a second subnetwork; and a UCD is included in the first subnetwork and the second subnetwork, wherein the method further comprises: communicating between the UCDs of the first subnetwork and UCDS of the second subnetwork.

Aspect 17. The method of any one of aspects 13 to 16, wherein the aggregate sensor dataset is encrypted and includes a customer identifier, the method further comprising: identifying, by the NCD, a decryption key associated with the customer identifier; and decrypting, by the NCD, the aggregate sensor dataset using the decryption key.

Aspect 18. The method of any one of aspects 13 to 17, wherein the method is further implemented by a management platform for providing operational support for the plurality of UCDs and associated portable structures, the management platform stored as processor-executable instructions on one or more memories and executed by one or more processors, the method further comprising: receiving, by the management platform from the data storage platform, the aggregate sensor dataset; analyzing, by the management platform, the aggregate sensor dataset to generate analytics for the portable structures; and providing, by the management platform, one or more support services based at least in part on the analytics.

Aspect 19. The method of aspect 18, wherein the management platform stores model data associated with a machine learning model trained using training data, the method further comprising executing, by the management platform, the machine learning model.

Aspect 20. A non-transitory computer-readable medium storing processor-executable instructions for operating a network of unit collection devices (UCDs) and implemented by a plurality of UCDs, wherein each UCD of the plurality of UCDs is associated with a respective portable structure and configured to operate as a node in a long-range wireless mesh network comprising the plurality of UCDs, and operate as a coordinator UCD for at least a portion of UCDs of the plurality of UCDs, and a network collection device (NCD) configured to collect an aggregate sensor dataset from the coordinator UCD, and provide the aggregate sensor dataset to a storage platform; and the instructions that, when executed by one or more processors, cause the one or more processors to at least: receive, from one or more sensors by the each UCD, sensor data indicating a status of the respective portable structure; provide, by the at least the portion of UCDs to the coordinator UCD, the sensor data; generate, by the coordinator UCD, an aggregate sensor dataset from the sensor data received from the at least the portion of UCDs, wherein the received sensor data includes UCD identifiers associated with the UCDs from which the sensor data is received; store, by the coordinator UCD, the aggregate sensor dataset locally on a memory; receive, by the NCD from the coordinator UCD, the aggregate sensor dataset in response to the NCD being within wireless communication range of the coordinator UCD; and provide, by the NCD to a data storage platform, the aggregate sensor dataset.

Aspect 21. A system for operating a network of unit collection devices (UCDs), the system comprising: a plurality of UCDs, wherein each UCD of the plurality of UCDs is associated with a respective portable structure and configured to: receive sensor data from one or more sensors, the sensor data indicating a status of the respective portable structure; operate as a node in a long-range wireless mesh network comprising the plurality of UCDs; and provide the sensor data to a coordinator UCD of the long-range wireless mesh network; and the coordinator UCD for at least a portion of UCDs of the plurality of UCDs, the coordinator UCD configured to: receive the sensor data from at least the portion of UCDs via the long-range wireless mesh network, wherein the received sensor data includes UCD identifiers associated with the UCDs from which the sensor data is received, generate an aggregate sensor dataset from the sensor data, store the aggregate sensor dataset locally on a memory, and provide the aggregate sensor dataset to a storage platform via one or more long-range communication connections.

Aspect 22. The system of aspect 21, wherein the coordinator UCD is at least one of the plurality of UCDs.

Aspect 23. The system of aspects 21 or 22, wherein at least one long-range communication connection, of the one or more long-range communication connections, is activated based upon the aggregate sensor dataset.

Aspect 24. The system of any one of aspects 21 to 23, wherein the at least one long-range communication connection is activated based upon the aggregate sensor dataset indicating movement of the portable structure associated with the aggregate sensor dataset.

Aspect 25. The system of any one of aspects 21 to 24, wherein the coordinator UCD is a base station.

Aspect 26. The system of any one of aspects 21 to 25, wherein the one or more long-range communication connections is selected from the group consisting of: long term evolution machine type communication, narrowband-internet of things, and satellite.

Aspect 27. The system of any one of aspects 21 to 26, wherein at least one of the one or more long-range communication connections is subscription-based.

Aspect 28. The system of any one of aspects 21 to 27, further comprising a management platform for providing operational support for the plurality of UCDs and associated portable structures, the management platform stored as processor-executable instructions on one or more memories that, when executed by one or more processors, cause the management platform to: analyze the aggregate sensor dataset to generate analytics for the portable structures; and provide, via the management platform, one or more support services based at least in part on the analytics.

Aspect 29. The system of aspect 28, further comprising instructions that, when executed by one or more processors, cause the management platform to: generate one or more electronic alerts based upon the aggregate sensor dataset; and provide the one or more electronic alerts to a user device and/or via the management platform.

Aspect 30. A method for operating a network of unit collection devices (UCDs) implemented by (i) a plurality of UCDs, wherein each UCD of the plurality of UCDs is associated with a respective portable structure and configured to operate as a node in a long-range wireless mesh network comprising the plurality of UCDs, and (ii) coordinator UCD for at least a portion of UCDs of the plurality of UCDs, the coordinator UCD configured to receive sensor data, generate an aggregate sensor dataset from the sensor data, and provide the aggregate sensor dataset to a storage platform, the method comprising: receiving, from one or more sensors by the each UCD, the sensor data indicating a status of the respective portable structure; providing, by the at least the portion of UCDs to the coordinator UCD via the long-range wireless mesh network, the sensor data; generating, by the coordinator UCD, an aggregate sensor dataset from the sensor data received from the at least the portion of UCDs, wherein the received sensor data includes UCD identifiers associated with the UCDs from which the sensor data is received; storing, by the coordinator UCD, the aggregate sensor dataset locally on a memory; and providing, by the coordinator UCD to a data storage platform via one or more long-range communication connections, the aggregate sensor dataset.

Aspect 31. The method of aspect 30, wherein the coordinator UCD is at least one of the plurality of UCDs.

Aspect 32. The method of aspects 30 or 31, wherein at least one long-range communication connection, of the one or more long-range communication connections, is activated based upon the aggregate sensor dataset.

Aspect 33. The method of aspect 32, wherein the at least one long-range communication connection is activated based upon the aggregate sensor dataset indicating movement of the portable structure associated with the aggregate sensor dataset.

Aspect 34. The method of any one of aspects 30 to 33, wherein the coordinator UCD is a base station.

Aspect 35. The method of any one of aspects 30 to 34, wherein the one or more long-range communication connections is selected from the group consisting of: long term evolution machine type communication, narrowband-internet of things, and satellite.

Aspect 36. The method of any one of aspects 30 to 35, wherein at least one of the one or more long-range communication connections is subscription-based.

Aspect 37. The method of any one of aspects 30 to 36, wherein the method is further implemented by a management platform for providing operational support for the plurality of UCDs and associated portable structures, the management platform stored as processor-executable instructions on one or more memories and executed by one or more processors, the method further comprising: receiving, by the management platform from the data storage platform, the aggregate sensor dataset; analyzing, by the management platform, the aggregate sensor dataset to generate analytics for the portable structures; and providing, via the management platform, one or more support services based at least in part on the analytics.

Aspect 38. The method of aspect 37, further comprising: generating, by the management platform, one or more electronic alerts based upon the aggregate sensor dataset; and providing the one or more electronic alerts via the management platform and/or to a user device by the management platform.

### Additional Considerations

With the foregoing, users whose data is being collected and/or utilized may first opt-in. After a user provides affirmative consent, data may be collected from the user's device (e.g., a mobile computing device). In other embodiments, deployment and use of ML models at a client or user device may have the benefit of removing any concerns of privacy or anonymity, by removing the need to send any personal or private data to a remote server.

The following additional considerations apply to the foregoing discussion. Throughout this specification, plural instances may implement operations or structures described as a single instance. Although individual operations of one or more methods are illustrated and described as separate operations, one or more of the individual operations may be performed concurrently, and nothing requires that the operations be performed in the order illustrated. These and other variations, modifications, additions, and improvements fall within the scope of the subject matter herein.

The patent claims at the end of this patent application are not intended to be construed under 35 U.S.C. § 112(f) unless traditional means-plus-function language is expressly recited, such as “means for” or “step for” language being explicitly recited in the claim(s). The systems and methods described herein are directed to an improvement to computer functionality, and improve the functioning of conventional computers.

Unless specifically stated otherwise, discussions herein using words such as

“processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment”, “in one aspect” and/or the like in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory product to which it is communicatively coupled. A further hardware module may then, at a later time, access the memory product to retrieve and process the stored output. Hardware modules may also initiate communications with input or output products, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a building environment, an office environment or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a building environment, an office environment, or a server farm). In other example embodiments, the one or more processors or processor-implemented modules may be distributed across a number of geographic locations.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

Upon reading this disclosure, those of skill in the art will appreciate still additional alternative structural and functional designs for the method and systems described herein through the principles disclosed herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

Thus, many modifications and variations may be made in the techniques, methods, and structures described and illustrated herein without departing from the spirit and scope of the present claims. Accordingly, it should be understood that the methods and apparatus described herein are illustrative only and are not limiting upon the scope of the claims.

What is claimed:

1. A method for operating a network of unit collection devices (UCDs) implemented by:
a plurality of UCDs, wherein each UCD of the plurality of UCDs is associated with a respective portable structure and configured to operate as a node in a long-range wireless mesh network comprising the plurality of UCDs, and operate as a coordinator UCD for at least a portion of UCDs of the plurality of UCDs, and
a network collection device (NCD) configured to collect an aggregate sensor dataset from the coordinator UCD, and provide the aggregate sensor dataset to a storage platform, the method comprising:
receiving, from one or more sensors by the each UCD, sensor data indicating a status of the respective portable structure;
providing, by the at least the portion of UCDs to the coordinator UCD, the sensor data;
generating, by the coordinator UCD, an aggregate sensor dataset from the sensor data received from at least the portion of UCDs, wherein the received sensor data includes UCD identifiers associated with the UCDs from which the sensor data is received;
storing, by the coordinator UCD, the aggregate sensor dataset locally on a memory;
receiving, by the NCD from the coordinator UCD, the aggregate sensor dataset based upon the NCD being within wireless communication range of the coordinator UCD; and
providing, by the NCD to a data storage platform, the aggregate sensor dataset.

2. The method of claim 1, wherein the sensor data indicates one or more of a location, a frequency of use, a hygiene level, a door lock status, or a level of a consumable product.

3. The method of claim 1, wherein the long-range wireless mesh network is a bidirectional mesh network based upon a LoRaWAN protocol.

4. The method of claim 1, further comprising:
obtaining, by the NCD for aggregate sensor dataset, expected UCD identifiers of the UCDs expected to provide the sensor data comprising the aggregate sensor dataset;
comparing, by the NCD, the expected UCD identifiers to the UCD identifiers of the aggregate sensor dataset to identify expected UCD identifiers not included within the UCD identifiers; and
wherein the expected UCD identifiers match the received UCD identifiers, providing, by the NCD, a notification indicating the aggregate sensor dataset is successfully received, or
wherein the expected UCD identifiers do not match the received UCD identifiers, identify, by the NCD, an additional coordinator NCD at which the sensor data associated with an unmatched expected UCD identifier is stored.

5. The method of claim 1, wherein the NCD is configured to receive the aggregate sensor dataset via a Bluetooth communication connection with the coordinator UCD.

6. The method of claim 1, wherein:
at least a first portion of the plurality of UCDs comprise a first subnetwork;
at least a second portion of the plurality of UCDs comprise a second subnetwork; and
a UCD is included in the first subnetwork and the second subnetwork, wherein the method further comprises:
communicating between the UCDs of the first subnetwork and UCDS of the second subnetwork.

7. The method of claim 6, wherein a UCD is included in the first subnetwork and the second subnetwork.

8. The method of claim 1, wherein the NCD is further configured to receive an additional aggregate sensor dataset from an additional coordinator UCD associated with an additional long-range wireless mesh network.

9. The method of claim 1, wherein the aggregate sensor dataset is encrypted and includes a customer identifier, the method further comprising:
identifying, by the NCD, a decryption key associated with the customer identifier; and
decrypting, by the NCD, the aggregate sensor dataset using the decryption key.

10. The method of claim 1, wherein the method is further implemented by a management platform for providing operational support for the plurality of UCDs and associated portable structures, the management platform stored as processor-executable instructions on one or more memories and executed by one or more processors, the method further comprising:
receiving, by the management platform from the data storage platform, the aggregate sensor dataset;
analyzing, by the management platform, the aggregate sensor dataset to generate analytics for the portable structures; and
providing, by the management platform, one or more support services based at least in part on the analytics.

11. The method of claim 10, wherein the management platform stores model data associated with a machine learning model trained using training data, the method further comprising executing, by the management platform, the machine learning model.

12. The method of claim 11, wherein the machine learning model is selected from the group consisting of a predictive analytics model and a route optimization model.

13. A method for operating a network of unit collection devices (UCDs) implemented by (i) a plurality of UCDs, wherein each UCD of the plurality of UCDs is associated with a respective portable structure and configured to operate as a node in a long-range wireless mesh network comprising the plurality of UCDs, and (ii) coordinator UCD for at least a portion of UCDs of the plurality of UCDs, the coordinator UCD configured to receive sensor data, generate an aggregate sensor dataset from the sensor data, and provide the aggregate sensor dataset to a storage platform, the method comprising:
receiving, from one or more sensors by the each UCD, the sensor data indicating a status of the respective portable structure;
providing, by the at least the portion of UCDs to the coordinator UCD via the long-range wireless mesh network, the sensor data;
generating, by the coordinator UCD, an aggregate sensor dataset from the sensor data received from the at least the portion of UCDs, wherein the received sensor data includes UCD identifiers associated with the UCDs from which the sensor data is received;
storing, by the coordinator UCD, the aggregate sensor dataset locally on a memory; and
providing, by the coordinator UCD to a data storage platform via one or more long-range communication connections, the aggregate sensor dataset.

14. The method of claim 13, wherein the coordinator UCD is at least one of the plurality of UCDs.

15. The method of claim 13, wherein at least one long-range communication connection, of the one or more long-range communication connections, is activated based upon the aggregate sensor dataset.

16. The method of claim 15, wherein the at least one long-range communication connection is activated based upon the aggregate sensor dataset indicating movement of the portable structure associated with the aggregate sensor dataset.

17. The method of claim 13, wherein the coordinator UCD is a base station.

18. The method of claim 13, wherein the one or more long-range communication connections is selected from the group consisting of: long term evolution machine type communication, narrowband-internet of things, and satellite.

19. The method of claim 13, wherein the method is further implemented by a management platform for providing operational support for the plurality of UCDs and associated portable structures, the management platform stored as processor-executable instructions on one or more memories and executed by one or more processors, the method further comprising:
receiving, by the management platform from the data storage platform, the aggregate sensor dataset;
analyzing, by the management platform, the aggregate sensor dataset to generate analytics for the portable structures; and
providing, via the management platform, one or more support services based at least in part on the analytics.

20. The method of claim 19, further comprising:
generating, by the management platform, one or more electronic alerts based upon the aggregate sensor dataset; and
providing the one or more electronic alerts via the management platform and/or to a user device by the management platform.
